(19) United States
(12) Patent Application Publication
(10) Pub. No.: US 2025/0147153 A1
(43) Pub. Date: May 8, 2025

(54) LIDAR ASSEMBLY AND APPARATUS WITH A DETECTION FUNCTION

(71) Applicant: BOE Technology Group Co., Ltd., Beijing (CN)

(72) Inventors: Yuehua LIU, Beijing (CN); Wei ZHAO, Beijing (CN); Baoman LI, Beijing (CN)

(21) Appl. No.: 18/993,762

(22) PCT Filed: Feb. 22, 2024
(86) PCT No.: PCT/CN2024/078181

§ 371 Date: Jan. 13, 2025

(30) Foreign Application Priority Data
Aug. 28, 2023 (CN) 202311088511.9

(51) Int. Cl. G01S 7/481; G01S 7/48; G01S 7/499; G01S 17/894

(52) U.S. Cl. CPC G01S 7/4817; G01S 7/4802; G01S 7/4814; G01S 7/499; G01S 17/894

(57) ABSTRACT

Disclosed are a LiDAR assembly and an apparatus with a detection function. The LiDAR assembly includes: a transmitter configured to emit first laser light along a first direction; a first scanner, where an input terminal of the first scanner faces to an output terminal of the transmitter, and the first scanner is configured to control the first laser light to be deflected from the first direction to a plurality of different first deflection directions, and emit the first laser light along the plurality of first deflection directions to a target object; a receiver configured to receive laser light reflected by the target object and convert an optical signal into an electrical signal; and a signal processing unit configured to receive the electrical signal, analyze and compute the electrical signal to obtain information about a distance from the target object and a shape of the target object.

### CROSS REFERENCE TO RELATED APPLICATIONS

The present application is a US National Stage of International Application No. PCT/CN2024/078181, filed on Feb. 22, 2024, which claims the priority from Chinese Patent Application No. 202311088511.9, filed with the China National Intellectual Property Administration on Aug. 28, 2023 and entitled “LiDAR Assembly and Apparatus with Detection Function”, which is hereby incorporated by reference in its entirety.

### TECHNICAL FIELD

The disclosure relates to the field of laser detection technology, and more particularly, to a LiDAR assembly and an apparatus with a detection function.

### BACKGROUND

Light Detection and Ranging (LiDAR) resolution is determined by LiDAR point cloud density, that is, the higher the point cloud density, the higher the resolution. The point cloud density is positively correlated with an equivalent number of channels of the LiDAR, that is, the greater the equivalent number of channels, the higher the point cloud density. Current LiDARs typically increase the equivalent number of channels by increasing the number of transmitters and receivers, which significantly raises the cost of the LiDAR.

### SUMMARY

In an aspect, embodiments of the disclosure provide a LIDAR assembly, including: a transmitter, a first scanner, a receiver and a signal processing unit. The transmitter is configured to emit first laser light along a first direction. An input terminal of the first scanner faces to an output terminal of the transmitter. The first scanner is configured to control the first laser light to be deflected from the first direction to a plurality of different first deflection directions, and emit the first laser light to a target object along the plurality of first deflection directions. At least one of the plurality of first deflection directions is different from the first direction. The receiver is configured to receive laser light reflected by the target object and convert an optical signal into an electrical signal. The signal processing unit is configured to receive the electrical signal, analyze and compute a received electrical signal to obtain information about a distance from the target object and a shape of the target object.

In one embodiment, an angle between the at least one of the plurality of first deflection directions and the first direction ranges from 0.5° to 10°.

In one embodiment, the first scanner includes a first optical element, a second optical element and a third optical element. The first optical element faces to the output terminal of the transmitter and is configured to convert a polarization state of the first laser light from a linear polarization state to a circular polarization state, or convert a polarization state of the first laser light from a circular polarization state to a linear polarization state. The second optical element is disposed on a side of the first optical element facing away from the transmitter, and is configured to deflect the first laser light from the first direction to the plurality of first deflection directions. The third optical element is disposed between the first optical element and the second optical element, and is configured to change or maintain the polarization state of the first laser light.

In one embodiment, the third optical element includes: a first substrate; a first transparent electrode layer on a side of the first substrate; a first alignment layer on a side of the first transparent electrode layer facing away from the first substrate; a second substrate at a side of the first alignment layer facing away from the first substrate; a second transparent electrode layer on a side of the second substrate facing to the first substrate; a second alignment layer on a side of the second transparent electrode layer facing to the first substrate; and a first liquid crystal layer between the first alignment layer and the second alignment layer. A first driving electric field is configured to be formed between the first transparent electrode layer and the second transparent electrode layer to change a deflection state of the first liquid crystal layer, to allow the polarization state of the first laser light to be changed or maintained.

In one embodiment, a thicknesses of each of the first substrate and the second substrate ranges from 100 μm to 700 μm; and/or, a thicknesses of each of the first transparent electrode layer and the second transparent electrode layer ranges from 0.05 μm to 2 μm; and/or, a thicknesses of the first alignment layer and the second alignment layer ranges from 0.01 μm to 0.5 μm; and/or, a thickness of the first liquid crystal layer ranges from 2 μm to 5 μm.

In one embodiment, the second optical element includes: a third substrate; a third alignment layer on a side of the third substrate; a packaging structure at a side of the third alignment layer facing away from the third substrate; and a second liquid crystal layer between the packaging structure and the third alignment layer.

In another embodiment, the second optical element includes: a fourth substrate; a third transparent electrode layer on a side of the fourth substrate; a fourth alignment layer on a side of the third transparent electrode layer facing away from the fourth substrate; a fifth substrate at a side of the fourth alignment layer facing away from the fourth substrate; a fourth transparent electrode layer on a the side of the fifth substrate facing to the fourth substrate; a fifth alignment layer on a side of the fourth transparent electrode layer facing to the fourth substrate; and a third liquid crystal layer between the fourth alignment layer and the fifth alignment layer. A second driving electric field is configured to be formed between the third transparent electrode layer and the fourth transparent electrode layer to change a deflection state of the third liquid crystal layer, to allow the first laser light to be deflected from the first direction to the plurality of first deflection directions.

In one embodiment, the LiDAR assembly further includes a transmitting optical component. An input terminal of the transmitting optical component faces to an output terminal of the first scanner. The first laser light along the plurality of first deflection directions is emitted to the target object via the transmitting optical component.

In one embodiment, the transmitting optical component includes: a first collimating lens, a first prism, and a first mirror arranged sequentially along an optical path of the first laser light. The first mirror is configured to direct the first laser light to the target object. Or, the transmitting optical component includes a second collimating lens, a second mirror, and a rotating mirror arranged sequentially along an optical path of the first laser light. The rotating mirror is configured to rotate around a rotation shaft and is configured to direct the first laser light to the target object. Or, the transmitting optical component includes: a resonance mirror for directing the first laser light to the target object. Or, the transmitting optical component includes: a divergent lens for directing the first laser light to the target object.

In one embodiment, the LiDAR assembly further includes a second scanner configured to control second laser light to be deflected from a plurality of different second deflection directions to a second direction, to allow the second laser light along the second direction to be transmitted to the receiver. The second laser light is light reflected by the target object for the first laser light, and at least one of the plurality of second deflection directions is different from the second direction.

In one embodiment, the second scanner includes: a fourth optical element positioned near the target object and configured to deflect the second laser light from the plurality of second deflection directions to the second direction; and a fifth optical element between the fourth optical element and the receiver and configured to change or maintain a polarization state of the second laser light.

In one embodiment, the second scanner further includes: a sixth optical element between the fifth optical element and the receiver and configured to convert the polarization state of the second laser light from a linear polarization state to a circular polarization state, or convert the polarization state of the second laser light from a circular polarization state to a linear polarization state.

In one embodiment, the LiDAR assembly further includes: a receiving optical component between the second scanner and the target object. The second laser light reflected by the target object is transmitted to the second scanner via the receiving optical component.

In one embodiment, the first scanner includes N second optical elements. The N second optical elements are sequentially arranged on the side of the first optical element facing away from the transmitter; and N is an integer greater than 1.

In one embodiment, polarization directions of the N second optical elements are different. A ratio of a deflection angle of a j-th one of the N second optical elements to a deflection angle of a first one of the N second optical elements is an integer greater than 1. Here, j is an integer greater than 1 and less than or equal to N. Among the N second elements, the first one of the N second optical elements is closest to the first optical element.

In one embodiment, the first scanner includes N third optical elements. The third optical elements and the second optical elements are alternately arranged on the side of the first optical element facing away from the transmitter. A first one of the N third optical element is disposed between the first one of the N second optical elements and the first optical element.

In one embodiment, the first scanner includes one third optical element. The N second optical elements are sequentially arranged on the side of the one third optical element facing away from the first optical element.

In one embodiment, a quantity of pointing angles of the first scanner is 2^{N+1}−1.

In one embodiment, the second scanner includes M fourth optical elements. The M fourth optical elements are sequentially arranged at a side of the target object. M is an integer greater than 1.

In another aspect, embodiments of the disclosure provide an apparatus with a detection function, including the LiDAR assembly of any of the aforementioned embodiments.

The technical solutions proposed by the embodiments of the disclosure ensure the equivalent number of channels of the LiDAR assembly while effectively reducing the number of transmitters, thereby lowering costs.

The above summary is provided for explanatory purposes and is not intended to limit the disclosure in any way. In addition to the illustrative aspects, embodiments, and features described above, further aspects, embodiments, and features of the disclosure will become readily apparent by reference to the accompanying drawings and detailed description that follows.

### BRIEF DESCRIPTION OF FIGURES

In the accompanying drawings, unless otherwise indicated, the same or similar reference numerals throughout multiple figures represent the same or similar components or elements. These drawings are not necessarily drawn to scale. It should be understood that the drawings merely describe some embodiments of the disclosure herein and should not be construed as limiting the scope of the disclosure.

FIG. 1 shows a schematic diagram illustrating laser emission for a first LiDAR assembly.

FIG. 2 shows a schematic diagram illustrating laser reception for a first LiDAR assembly.

FIG. 3 shows a schematic diagram illustrating laser emission and reception for a second LIDAR assembly.

FIG. 4 shows a schematic diagram illustrating laser emission for a third LiDAR assembly.

FIG. 5 shows a schematic diagram illustrating laser reception for a third LiDAR assembly.

FIG. 6 shows a schematic diagram illustrating laser emission for a fourth LiDAR assembly.

FIG. 7 shows a schematic diagram illustrating laser reception for a fourth LiDAR assembly.

FIG. 8 shows a structural schematic diagram of a LIDAR assembly according to an embodiment of the disclosure.

FIG. 9 illustrates a working schematic diagram of the LiDAR assembly shown in FIG. 8.

FIG. 10 shows a structural schematic of a LIDAR assembly according to another embodiment of the disclosure.

FIG. 11 illustrates a working schematic diagram of the LiDAR assembly shown in FIG. 10.

FIGS. 12-15 illustrate structural schematic diagrams of a first scanner according to embodiments of the disclosure.

FIGS. 16-18 illustrate structural schematic diagrams of a third optical element according to embodiments of the disclosure.

FIG. 19 illustrates a preparation flowchart for the third optical element according to embodiments of the disclosure.

FIGS. 20-25 illustrate structural schematic diagrams of a second optical element according to embodiments of the disclosure.

FIGS. 26 and 27 illustrate preparation flowcharts for the second optical element according to embodiments of the disclosure.

FIGS. 28 and 29 show schematic diagrams illustrating laser emission for a LIDAR assembly according to a first embodiment of the disclosure.

FIGS. 30 and 31 show schematic diagrams illustrating laser reception for a LiDAR assembly according to the first embodiment of the disclosure.

FIGS. 32 and 33 show schematic diagrams illustrating laser emission and reception for a LIDAR assembly according to a second embodiment of the disclosure.

FIGS. 34 and 35 show schematic diagrams illustrating laser emission for a LIDAR assembly according to a third embodiment of the disclosure.

FIGS. 36 and 37 show schematic diagrams illustrating laser reception for a LIDAR assembly according to the third embodiment of the disclosure.

FIG. 38 shows a schematic diagram illustrating laser emission for a LIDAR assembly according to a fourth embodiment of the disclosure.

FIG. 39 shows a schematic diagram illustrating laser reception for a LiDAR assembly according to the fourth embodiment of the disclosure.

FIG. 40 shows a schematic diagram illustrating laser emission for a LiDAR assembly according to a fifth embodiment of the disclosure.

FIG. 41 illustrates application examples of an apparatus with a detection function according to embodiments of the disclosure.

FIG. 42 shows an exemplary diagram of a first simulation structure of the first scanner according to embodiments of the disclosure.

FIG. 43 illustrates an electric field distribution diagram when a voltage of V1=0 V is applied between a first transparent electrode layer and a second transparent electrode layer of a nematic liquid crystal half-wave plate, and a voltage of V3=0 V is applied between a third transparent electrode layer and a fourth transparent electrode layer of a single-layer nematic liquid crystal polarization grating according to an embodiment of the disclosure.

FIG. 44 illustrates a polarization conversion diagram for linearly polarized incident light and circularly polarized outgoing light when a voltage of V1=0 V is applied to the nematic liquid crystal half-wave plate and a voltage of V3=0 V is applied to the single-layer nematic liquid crystal polarization grating according to an embodiment of the disclosure.

FIG. 45 illustrates an electric field distribution diagram when a saturation voltage V2 is applied between the first transparent electrode layer and the second transparent electrode layer of the nematic liquid crystal half-wave plate, and a voltage of V3=0 V is applied between the third transparent electrode layer and the fourth transparent electrode layer of the single-layer nematic liquid crystal polarization grating according to an embodiment of the disclosure.

FIG. 46 illustrates a polarization conversion diagram for linearly polarized incident light and circularly polarized outgoing light when a saturation voltage V2 is applied to the nematic liquid crystal half-wave plate, and a voltage of V3=0 V is applied to the single-layer nematic liquid crystal polarization grating according to an embodiment of the disclosure.

FIG. 47 illustrates an exemplary diagram of a second simulation structure of the first scanner according to an embodiment of the disclosure.

FIG. 48 illustrates an electric field distribution diagram when a voltage of V1=0 V is applied between a first transparent electrode layer and a second transparent electrode layer of the dual-layer twisted nematic liquid crystal half-wave plate, and a voltage of V3=0 V is applied between a third transparent electrode layer and a fourth transparent electrode layer of the single-layer nematic liquid crystal polarization grating according to an embodiment of the disclosure.

FIG. 49 illustrates a polarization conversion diagram for linearly polarized incident light and circularly polarized outgoing light when a voltage of V1=0 V is applied to the dual-layer twisted nematic liquid crystal half-wave plate, and a voltage of V3=0 V is applied to the single-layer nematic liquid crystal polarization grating according to an embodiment of the disclosure.

FIG. 50 illustrates an electric field distribution diagram when a saturation voltage V2 is applied between the first transparent electrode layer and the second transparent electrode layer of the dual-layer twisted nematic liquid crystal half-wave plate, and a voltage of V3=0 V is applied between the third transparent electrode layer and the fourth transparent electrode layer of the single-layer nematic liquid crystal polarization grating according to an embodiment of the disclosure.

FIG. 51 illustrates a polarization conversion diagram for linearly polarized incident light and circularly polarized outgoing light when a saturation voltage V2 is applied to the dual-layer twisted nematic liquid crystal half-wave plate, and a voltage of V3=0 V is applied to the single-layer nematic liquid crystal polarization grating according to an embodiment of the disclosure.

FIG. 52 illustrates an exemplary diagram of a third simulation structure of the first scanner according to an embodiment of the disclosure.

FIG. 53 illustrates an electric field distribution diagram when a voltage of V1=0 V is applied between a first transparent electrode layer and the second transparent electrode layer of a nematic liquid crystal half-wave plate, and a voltage of V3=0 V is applied between a third transparent electrode layer and a fourth transparent electrode layer of a dual-layer twisted nematic liquid crystal polarization grating according to an embodiment of the disclosure.

FIG. 54 illustrates a polarization conversion diagram for linearly polarized incident light and circularly polarized outgoing light when a voltage of V1=0 V is applied to the nematic liquid crystal half-wave plate, and a voltage of V3=0 V is applied to the dual-layer twisted nematic liquid crystal polarization grating according to an embodiment of the disclosure.

FIG. 55 illustrates an electric field distribution diagram when a saturation voltage V2 is applied between the first transparent electrode layer and the second transparent electrode layer of the nematic liquid crystal half-wave plate, and a voltage of V3=0 V is applied between the third transparent electrode layer and the fourth transparent electrode layer of the dual-layer twisted nematic liquid crystal polarization grating according to an embodiment of the disclosure.

FIG. 56 illustrates a polarization conversion diagram for linearly polarized incident light and circularly polarized outgoing light when a saturation voltage V2 is applied to the nematic liquid crystal half-wave plate, and a voltage of V3=0 V is applied to the dual-layer twisted nematic liquid crystal polarization grating according to an embodiment of the disclosure.

FIG. 57 illustrates an exemplary diagram of a fourth simulation structure of the first scanner according to an embodiment of the disclosure.

FIG. 58 illustrates an electric field distribution diagram when a voltage of V1=0 V is applied between a first transparent electrode layer and a second transparent electrode layer of a dual-layer twisted nematic liquid crystal half-wave plate, and a voltage of V3=0 V is applied between a third transparent electrode layer and a fourth transparent electrode layer of a dual-layer twisted nematic liquid crystal polarization grating according to an embodiment of the disclosure.

FIG. 59 illustrates the polarization conversion diagram for linearly polarized incident light and circularly polarized outgoing light when a voltage of V1=0 V is applied to the dual-layer twisted nematic liquid crystal half-wave plate, and a voltage of V3=0 V is applied to the dual-layer twisted nematic liquid crystal polarization grating according to an embodiment of the disclosure.

FIG. 60 illustrates an electric field distribution diagram when a saturation voltage V2 is applied between a first transparent electrode layer and a second transparent electrode layer of a dual-layer twisted nematic liquid crystal half-wave plate, and a voltage of V3=0 V is applied between a third transparent electrode layer and a fourth transparent electrode layer of a dual-layer twisted nematic liquid crystal polarization grating according to an embodiment of the disclosure.

FIG. 61 illustrates a polarization conversion diagram for linearly polarized incident light and circularly polarized outgoing light when a saturation voltage V2 is applied to the dual-layer twisted nematic liquid crystal half-wave plate, and a voltage of V3=0 V is applied to the dual-layer twisted nematic liquid crystal polarization grating according to an embodiment of the disclosure.

FIG. 62 illustrates an electric field distribution diagram when a saturation voltage V2 is applied to a first transparent electrode layer and a second transparent electrode layer of a single-layer nematic liquid crystal half-wave plate, and a saturation voltage V4 is applied to a third transparent electrode layer and a fourth transparent electrode layer of a single-layer nematic liquid crystal polarization grating according to an embodiment of the disclosure.

FIG. 63 illustrates a polarization conversion diagram for linearly polarized incident light and circularly polarized outgoing light when a saturation voltage V2 is applied to the single-layer nematic liquid crystal half-wave plate, and a saturation voltage V4 is applied to the single-layer nematic liquid crystal polarization grating according to an embodiment of the disclosure.

FIG. 64 illustrates an electric field distribution diagram when a saturation voltage V2 is applied between a first transparent electrode layer and a second transparent electrode layer of the dual-layer twisted nematic liquid crystal half-wave plate, and a saturation voltage V4 is applied between a third transparent electrode layer and a fourth transparent electrode layer of a single-layer nematic liquid crystal polarization grating according to an embodiment of the disclosure.

FIG. 65 illustrates a polarization conversion diagram for linearly polarized incident light and circularly polarized outgoing light when a saturation voltage V2 is applied to the dual-layer twisted nematic liquid crystal half-wave plate, and a saturation voltage V4 is applied to the single-layer nematic liquid crystal polarization grating according to an embodiment of the disclosure.

FIG. 66 illustrates an electric field distribution diagram when a saturation voltage V2 is applied between a first transparent electrode layer and a second transparent electrode layer of a nematic liquid crystal half-wave plate, and a saturation voltage V4 is applied between a third transparent electrode layer and a fourth transparent electrode layer of the dual-layer twisted nematic liquid crystal polarization grating according to an embodiment of the disclosure.

FIG. 67 illustrates a polarization conversion diagram for linearly polarized incident light and circularly polarized outgoing light when a saturation voltage V2 is applied to the nematic liquid crystal half-wave plate, and a saturation voltage V4 is applied to the dual-layer twisted nematic liquid crystal polarization grating according to an embodiment of the disclosure.

FIG. 68 illustrates an electric field distribution diagram when a saturation voltage V2 is applied between a first transparent electrode layer and a second transparent electrode layer of a dual-layer twisted nematic liquid crystal half-wave plate, and a saturation voltage V4 is applied between a third transparent electrode layer and a fourth transparent electrode layer of a dual-layer twisted nematic liquid crystal polarization grating according to an embodiment of the disclosure.

FIG. 69 illustrates a polarization conversion diagram for linearly polarized incident light and circularly polarized outgoing light when a saturation voltage V2 is applied to the dual-layer twisted nematic liquid crystal half-wave plate, and a saturation voltage V4 is applied to the dual-layer twisted nematic liquid crystal polarization grating according to an embodiment of the disclosure.

FIG. 70 illustrates a schematic diagram of another structure of the first scanner according to an embodiment of the disclosure.

FIG. 71 illustrates a schematic diagram of yet another structure of the first scanner according to an embodiment of the disclosure.

### REFERENCE SIGNS

10: LIDAR assembly; 100: transmitter; 200: first scanner; 210: first optical element;
220: second optical element; 221: third substrate; 222: third alignment layer;
223: packaging structure; 224: second liquid crystal layer; 225: fourth substrate;
226: third transparent electrode layer; 227: fourth alignment layer; 228: fifth substrate;
229: fourth transparent electrode layer; 22a: fifth alignment layer;
22b: third liquid crystal layer; 22c: third anti-reflection coating;
22d: fourth anti-reflection coating; 22e: fifth anti-reflection coating;
22f: sixth anti-reflection coating; 22g: second spacer; 230: third optical element;
231: first substrate; 232: first transparent electrode layer; 233: first alignment layer;
234: second substrate; 235: second transparent electrode layer;
236: second alignment layer; 237: first liquid crystal layer;
23a: first anti-reflection coating; 23b: second antireflection film; 23c: first spacer;
31a: first collimating lens; 31b: first prism; 31c: first mirror; 31d: second collimating lens;
31e: second mirror; 31f: rotating mirror; 31g: rotation shaft; 31h: resonance mirror;
31i: diverging lens; 400: second scanner; 410: fourth optical element;
420: fifth optical element; 430: sixth optical element; 500: receiver;
700: scanning module; 800: focusing lens; 20: target object; F1: first direction;
F1′: first deflection direction; F2: second direction; F2′: second deflection direction.

### DETAILED DESCRIPTION

The following describes only some exemplary embodiments. For those skilled in the art, the described embodiments can be modified in various ways without departing from the spirit or scope of the disclosure. Therefore, the drawings and description are considered to be illustrative rather than limiting.

Currently, there are two methods for achieving large-angle range detection by LiDAR. In one method, a LiDAR assembly with a scanner device is used, which can perform rapid beam scanning across a wide angle range to detect targets over a large angle range, such as mechanical LiDAR assembly, rotating mirror LiDAR assembly, and micro-electro-mechanical system (MEMS) LiDAR assembly. In the other method, flash LiDAR is used, which simultaneously emits a laser beam from a vertical-cavity surface-emitting laser (VCSEL) array. The laser beam is expanded by a diverging lens to form surface light that illuminates the target object. The reflected light is received by a detector after being focused by a focusing lens, and a distance from the target object and a shape of the target object are calculated using a time-of-flight method by a signal processing background. Both methods require high point cloud density for fine 3D measurements, often needing lots of transmitters and detectors.

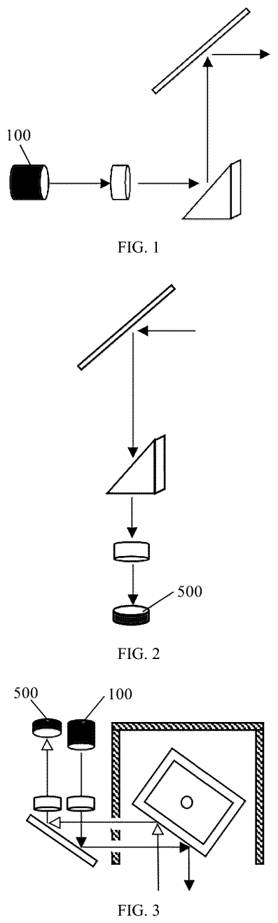

FIG. 1 shows a schematic diagram illustrating laser emission for a first LiDAR assembly, and FIG. 2 shows a schematic diagram illustrating laser reception for the first LiDAR assembly. The LiDAR assembly shown in FIGS. 1 and 2 is a mechanical LiDAR assembly. As shown in FIG. 1, a transmitter 100 emits laser light, which is focused and collimated by a collimating lens, then reflected by a prism to a rotating mirror. The rotating mirror directs the laser light to a target object. As shown in FIG. 2, the laser light reflected by the target object is reflected by the rotating mirror, passes through the prism, and is focused by the collimating lens before being received by the receiver 500. After data processing and 3D environment model modeling by a processing chip, the distance from the target object and the shape of the target object are determined.

FIG. 3 shows a schematic diagram illustrating laser emission and reception for the second LiDAR assembly. The LiDAR assembly shown in FIG. 3 is a rotating mirror LiDAR assembly. As shown in FIG. 3, the transmitter 100 emits laser light, which is focused and collimated by a collimating lens, then reflected by a fixed mirror through an aperture to a rotating mirror 31f. The rotating mirror 31f directs the laser light to a target object. The laser reception flow is the opposite of the emission flow. The laser light reflected by the target object passes through the rotating mirror after rotation, reaches the fixed mirror through the aperture, and is reflected to the collimating lens for focusing and collimation. It is then received by the receiver 500, converted into an electrical signal, and sent to the processing unit for data processing to determine the distance from the target object and a shape of the target object.

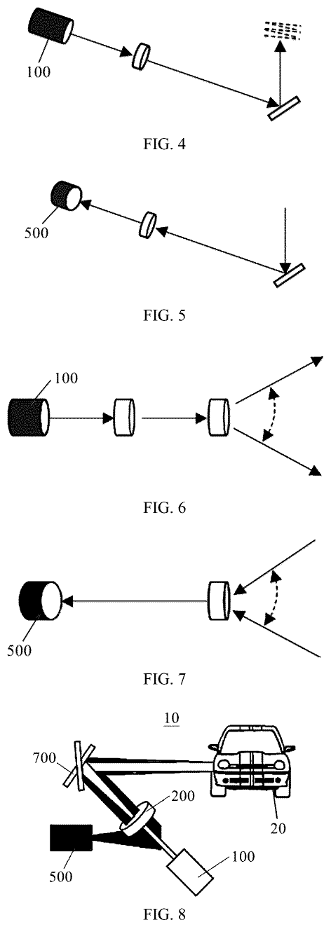

FIG. 4 shows a schematic diagram illustrating laser emission for a third LiDAR assembly, and FIG. 5 shows a schematic diagram illustraing laser reception for the third LiDAR assembly. The LiDAR assembly shown in FIGS. 4 and 5 is a MEMS LiDAR assembly. As shown in FIG. 4, the transmitter 100 emits laser light, which is focused and collimated by a collimating lens, then directed to a target object by the MEMS resonance mirror. As shown in FIG. 5, the light reflected by the target object passes through the MEMS resonance mirror, is focused and collimated by the collimating lens, and then received by the receiver 500. After data processing and 3D environment modeling by the processing chip, the distance from the target object and a shape of the target object can be determined.

FIG. 6 shows a schematic diagram illustrating laser emission for a fourth LiDAR assembly, and FIG. 7 shows a schematic diagram illustrating laser reception for the fourth LiDAR assembly. The LiDAR assembly shown in FIGS. 6 and 7 is a FLASH LiDAR assembly. As shown in FIG. 6, the transmitter 100 emits laser light, which is focused and collimated by a collimating lens, and then reaches a diverging lens for increasing the beam angle. This causes a power per unit area of the laser light to decrease. As shown in FIG. 7, the laser light reflected by the target object is focused and collimated by a collimating lens before being received by the receiver 500 and converted into an electrical signal. After data processing and 3D environment modeling by the processing chip, the distance from the target object and the shape of the target object can be determined.

All of the above four LiDAR assemblies are of single-channel type. For example, to achieve an effect of point cloud for a 128-channel LiDAR assembly, 128 transmitters 100 and 128 receivers are required. Therefore, to increase the equivalent number of channels for LiDAR, the number of transmitters 100 and receivers 500 must be increased, which leads to high costs.

FIG. 8 shows a schematic structural diagram of a LiDAR assembly 10 according to an embodiment of the disclosure. As shown in FIG. 8, the LiDAR assembly 10 includes a transmitter 100 and a first scanner 200.

Specifically, the transmitter 100 is used to emit first laser light along a first direction. An input terminal of the first scanner 200 faces to an output terminal of the transmitter 100, and the first scanner 200 is configured to control the first laser light to be deflected from the first direction to a plurality of different first deflection directions, and emit the first laser along the plurality of first deflection directions toward a target object 20. At least one of the plurality of first deflection direction is different from the first direction. In the context of this disclosure, “a plurality” means two or more.

It should be noted that “emit the first laser along the plurality of first deflection directions toward the target object 20” means that the first laser is emitted in the plurality of first deflection directions from the output terminal of the first scanner 200, rather than that the first laser reaches the target object 20 along the plurality of first deflection directions.

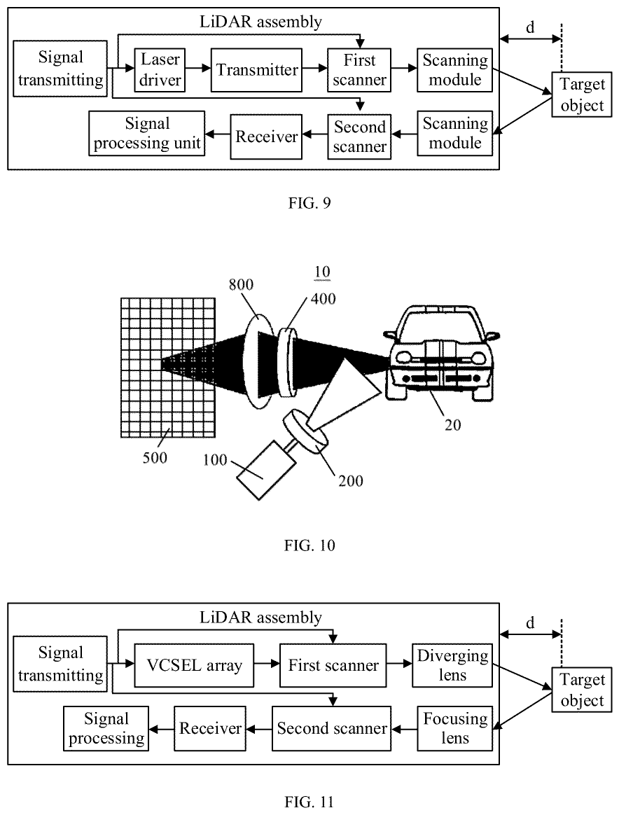

FIG. 9 shows a schematic working diagram of the LiDAR assembly 10 shown in FIG. 8. By combining FIGS. 8 and 9, the LiDAR assembly 10 can further include a signal sending unit, a laser driver, and a scanning module 700. The signal sending unit emits electrical signals, which are converted into laser signals by the laser driver and transmitter 100 for emitting. The first laser light passes through the first scanner 200, which allows for small-angle deflection of the first laser light, so that the first direction changes to the plurality of different first deflection directions. For example, an angle betwee the first direction and at least one of the plurality of first deflection directions can range from 0.5° to 10° (inclusive). After passing through the scanning module 700, the first laser light undergoes large-angle deflection and is ultimately emitted to the target object 20. For example, in the case where the first scanner 200 controls the first laser light to be deflected from the first direction into two different first deflection directions, one first laser beam can be split into two laser beams with different directions after passing through the first scanner 200. For achieving the effect of the point cloud for a 128-channel LiDAR assembly, only 64 transmitters and 64 receivers are required. Compared to a single-channel LiDAR assembly, the number of transmitters and receivers is halved, effectively reducing costs. Here, the transmitter 100 can be a laser.

FIG. 10 shows a schematic structural diagram of the LiDAR assembly 10 according to another embodiment of the disclosure, and FIG. 11 shows a schematic working diagram of the LIDAR assembly 10 shown in FIG. 10. Exemplarily, the transmitter 100 is a VCSEL array. The LIDAR assembly 10 can further include a signal transmission unit and a diverging lens. The signal transmission unit transmits an electrical signal to drive the VCSEL array to simultaneously emit a beam of first laser light. The first laser light passes through the first scanner 200, undergoing small-angle deflection from the first direction to a plurality of different first deflection directions. For example, an angle between the first direction and at least one of the plurality of first deflection directions can be 0.5° to 10°. Then, the laser light passes through the diverging lens to expand the beam, causing the first laser light to become surface light for illuminating the target object 20.

Based on the LiDAR assembly 10 according to embodiments of the disclosure, the first scanner 200 is provided and its input terminal faces to the output terminal of the transmitter 100, while ensuring the equivalent number of channels of the LiDAR assembly 10, the number of transmitters 100 can be effectively reduced, thus lowering the cost.

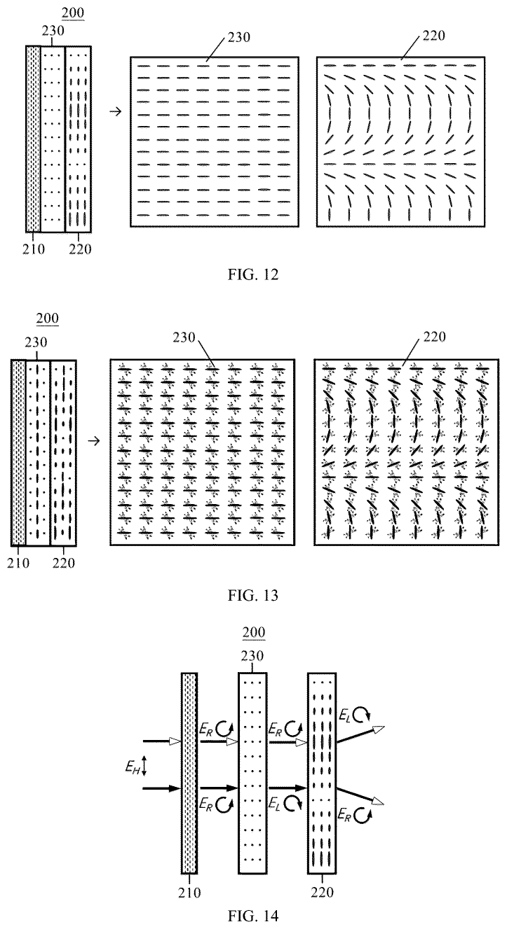

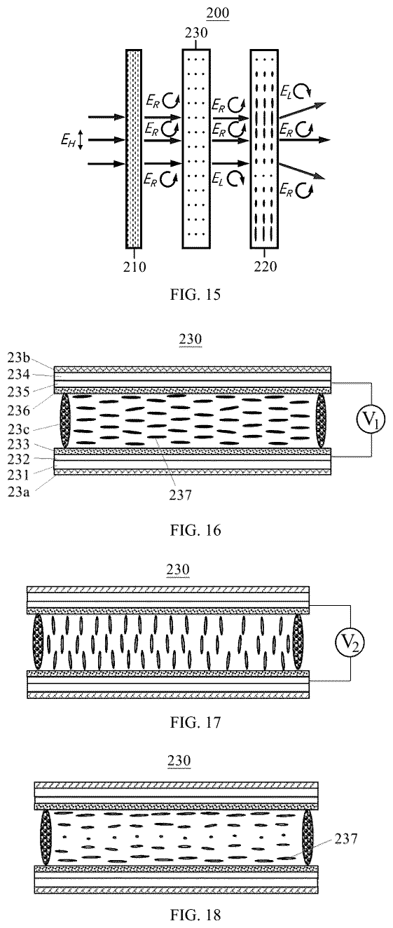

FIGS. 12 to 15 show schematic structural diagrams of the first scanner 200 according to embodiments of the disclosure. In one embodiment, referring to FIGS. 8, 12 to 15, the first scanner 200 includes a first optical element 210, a second optical element 220, and a third optical element 230. The first optical element 210 faces to the output terminal of the transmitter 100 and is used to convert the polarization state of the first laser light from a linear polarization state to a circular polarization state or from a circular polarization state to a linear polarization state. The second optical element 220 is disposed on a side of the first optical element 210 facing away from the transmitter 100 and is used to deflect the first laser light from the first direction to a plurality of first deflection directions. The third optical element 230 is disposed between the first optical element 210 and the second optical element 220 and is used to change or maintain the polarization state of the first laser light.

Exemplarily, the first laser light emitted from the output terminal of the transmitter 100 first enters the first optical element 210. After being converted from a linear polarization state to a circular polarization state by the first optical element 210, the first laser light enters the third optical element 230. After passing through the third optical element 230, a left-handed circular polarization state is converted to a right-handed circular polarization state, or vice versa, or the current circular polarization state is maintained. The first laser light then enters the second optical element 220, which deflects the first laser light from the first direction to the plurality of first deflection directions, to allow the second optical element 200 to emit the first laser light along the plurality of first deflection directions. The first optical element may be a ¼ wavelength plate.

Optionally, a wavelength of the first laser light emitted from the output terminal of the transmitter 100 may range from 0 nm to 1550 nm (inclusive of endpoint values), but it is not limited to this range.

In this embodiment, by setting the above-mentioned first optical element 210, second optical element 220, and third optical element 230, the equivalent number of channels of the LIDAR assembly 10 can be increased, thereby reducing the number of transmitters 100 and lowering the cost.

FIGS. 16 to 18 show schematic structural diagrams of the third optical element 230 according to embodiments of the disclosure. In one embodiment, as shown in FIGS. 8, 12, and 16 to 18, the third optical element 230 includes a first substrate 231, a first transparent electrode layer 232, a first alignment layer 233, a second substrate 234, a second transparent electrode layer 235, a second alignment layer 236, and a first liquid crystal layer 237. The first transparent electrode layer 232 is disposed on a side of the first substrate 231. The first alignment layer 233 is disposed on a side of the first transparent electrode layer 232 facing away from the first substrate 231. The second substrate 234 is positioned at a side of the first alignment layer 233 facing away from the first substrate 231. The second transparent electrode layer 235 is disposed on a side of the second substrate 234 facing to the first substrate 231. The second alignment layer 236 is disposed on a side of the second transparent electrode layer 235 facing to the first substrate 231. The first liquid crystal layer 237 is disposed between the first alignment layer 233 and the second alignment layer 236. A first driving electric field is configured to be formed between the first transparent electrode layer 232 and the second transparent electrode layer 235. The first driving electric field is used to change a deflection state of the first liquid crystal layer 237 to change or maintain the polarization state of the first laser.

Exemplarily, the material of the first substrate 231 and the second substrate 234 may be high-transparency glass. The material of the first transparent electrode layer 232 and the second transparent electrode layer 235 may be indium tin oxide (ITO). Depending on the preparation process, the first alignment layer 233 and the second alignment layer 236 may be rubbing alignment layers or photoalignment layers. In the case of rubbing alignment layers, the material of the first alignment layer 233 and the second alignment layer 236 may be polyimide (PI). In the case of photoalignment layers, the materials of the first alignment layer 233 and the second alignment layer 236 may include azobenzene (sulfonic azo dye, SD1), polyvinyl-4-methoxy cinnamate (PVMC), or photosensitive polyimide. The molecules of the first liquid crystal layer 237 are aligned in the same direction. The third optical element 230 may also include a first anti-reflection coating 23a, a second anti-reflection coating 23b, and a first spacer 23c. The first anti-reflection coating 23a is disposed on the side of the first substrate 231 facing away from the first transparent electrode layer 232, and the second anti-reflection coating 23b is disposed on the side of the second substrate 234 facing away from the second transparent electrode layer 235. The first spacer 23c is disposed between the first alignment layer 233 and the second alignment layer 236, and a diameter of the first spacer 23c may match a cell gap, serving to support and uniformly distribute the cell gap. The first spacer 23c can be a frame glue mixed with polystyrene microspheres.

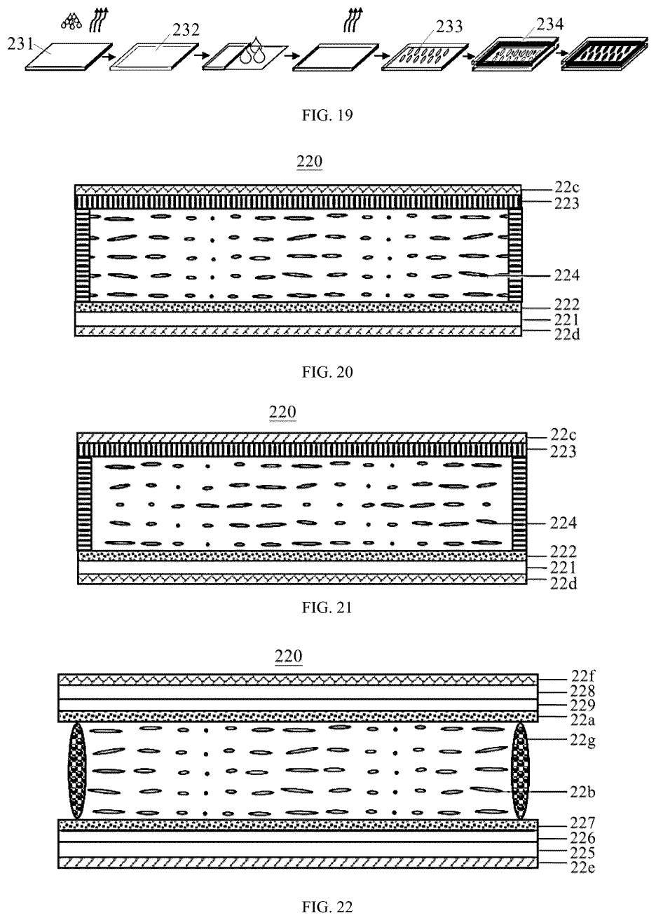

FIG. 19 shows a preparation flowchart of the third optical element 230 according to embodiments of the disclosure, in which the material of the first alignment layer 233 and the second alignment layer 236 can be PI. As shown in FIGS. 16 and 19, during preparation, the first substrate 231 is cleaned with deionized water and then dried. Next, ITO is deposited using a magnetron sputtering process to form the first transparent electrode layer 232. Afterward, a PI layer is spin-coated, dried, and aligned by rubbing with velvet cloth to form the first alignment layer 233. The prepared structure is then aligned with a structure including the second substrate 234 and the second transparent electrode layer 235 deposited on the second substrate 234. The first transparent electrode layer 232 and the second transparent electrode layer 235 are oppositely arranged, with the first spacer 23c determining the liquid crystal cell gap. Afterward, the liquid crystal is vacuum-filled to form the first liquid crystal layer 237, and finally, the structure is sealed, completing the preparation of the third optical element 230. In the case of the third optical element 230 being a single-layer nematic liquid crystal half-wave plate, the liquid crystals in the first liquid crystal layer 237 are nematic liquid crystals. If the third optical element 230 is a dual-layer twisted nematic liquid crystal half-wave plate, the liquid crystals in the first liquid crystal layer 237 are liquid crystals in a clockwise/counterclockwise spiral arrangement formed by adding chiral polymers to the nematic liquid crystals.

A thickness of each of the first substrate 231 and the second substrate 234 can be in the range of 100 μm to 700 μm (inclusive); a thickness of each of the first transparent electrode layer 232 and the second transparent electrode layer 235 can be in the range of 0.05 μm to 2 μm (inclusive); a thickness of each of the first alignment layer 233 and the second alignment layer 236 can be in the range of 0.01 μm to 0.5 μm (inclusive); a thickness of the first liquid crystal layer 237 can be in the range of 2 μm to 5 μm (inclusive); and a thickness of each of the first anti-reflection coating 23a and the second anti-reflection coating 23b can be in the range of 0.2 μm to 1 μm (inclusive).

Optionally, the third optical element 230 can be a single-layer nematic liquid crystal half-wave plate or a dual-layer twisted nematic liquid crystal half-wave plate.

In the case where the third optical element 230 is a single-layer nematic liquid crystal half-wave plate, the thickness d of the first liquid crystal layer 237 is controlled as d=λ/2Δn, where λ is a wavelength of the first laser light entering the third optical element 230, and Δn is a refractive index difference of the liquid crystal in the first liquid crystal layer 237. When the voltage V1=0 V is applied between the first transparent electrode layer 232 and the second transparent electrode layer 235, the liquid crystal in the first liquid crystal layer 237 does not undergo deflection, and the third optical element 230 acts as a half-wave plate, which can alter the polarization state of the first laser light. If the first laser light entering the third optical element 230 is left-handed circularly polarized light, the first laser light emerging from the third optical element 230 is right-handed circularly polarized light. If the first laser light entering the third optical element 230 is right-handed circularly polarized light, the first laser light emerging from the third optical element 230 is left-handed circularly polarized light. When a saturation voltage V2 is applied between the first transparent electrode layer 232 and the second transparent electrode layer 235, a driving electric field is formed between the first transparent electrode layer 232 and the second transparent electrode layer 235. The liquid crystal molecules in the first liquid crystal layer 237 rearrange under the influence of the driving electric field, and the long axes of the liquid crystal molecules align with the electric field direction. In this case, the third optical element 230 acts as a full-wave plate, maintaining the polarization state of the first laser light. If the first laser light entering the third optical element 230 is left-handed circularly polarized light, the first laser light emerging from the third optical element 230 remains left-handed circularly polarized light. If the first laser entering the third optical element 230 is right-handed circularly polarized light, the first laser emerging from the third optical element 230 remains right-handed circularly polarized light.

In the case where the third optical element 230 is a dual-layer twisted nematic liquid crystal half-wave plate, a difference from the single-layer nematic liquid crystal half-wave plate is the structure of the first liquid crystal layer 237, which now has a mirror-symmetric structure. The upper half of the liquid crystal in the first liquid crystal layer 237 is arranged in a clockwise helical orientation, while the lower half of the liquid crystal is arranged in a counterclockwise helical orientation. The first liquid crystal layer 237 functions as a half-wave plate to alter the polarization state of the first laser light.

In one application example, the second optical element 220 can be a liquid crystal polarization grating. The liquid crystal polarization grating uses the periodic arrangement of the liquid crystal director to adjust the polarization state of the incident light, achieving a beam-splitting function. For example, with the liquid crystal director periodically distributed along the x-axis, the director of the liquid crystal molecules can be described as:

$$α = \frac{- π x}{Λ} + {α}_{0} ,$$

where Λ is the period of the liquid crystal polarization grating, and α0 is the initial orientation angle of the liquid crystal. The transmittance of the liquid crystal polarization grating can be described using the Jones matrix as:

$$T = R ( - α ) [ \begin{matrix}1 & 0 \\ 0 & exp ( i Γ )\end{matrix} ] R ( α ) ,$$

where the rotation matrix

$$R ( α ) = [ \begin{matrix}cos α & - sin α \\ sin α & cos α\end{matrix} ] , Γ = \frac{2 π}{λ} Δ nd$$

is the dynamic phase in the liquid crystal, and the transmittance

$$T = cos \frac{Γ}{2} [ \begin{matrix}1 & 0 \\ 0 & 1\end{matrix} ] - {ie}^{i 2 α} sin \frac{Γ}{2} [ \begin{matrix}1 & i \\ i & - 1\end{matrix} ] - {ie}^{- i 2 α} sin \frac{Γ}{2} [ \begin{matrix}1 & - i \\ - i & - 1\end{matrix} ] .$$

The diffraction angle θ can be calculated using the grating equation. Here,

$$θ = \pm arcsin \frac{λ}{Λ} ,$$

where λ is the wavelength of the incident light, and A is the period of the liquid crystal polarization grating. Therefore, by altering the period of the liquid crystal polarization grating, liquid crystal polarization grating with different deflection angles can be achieved.

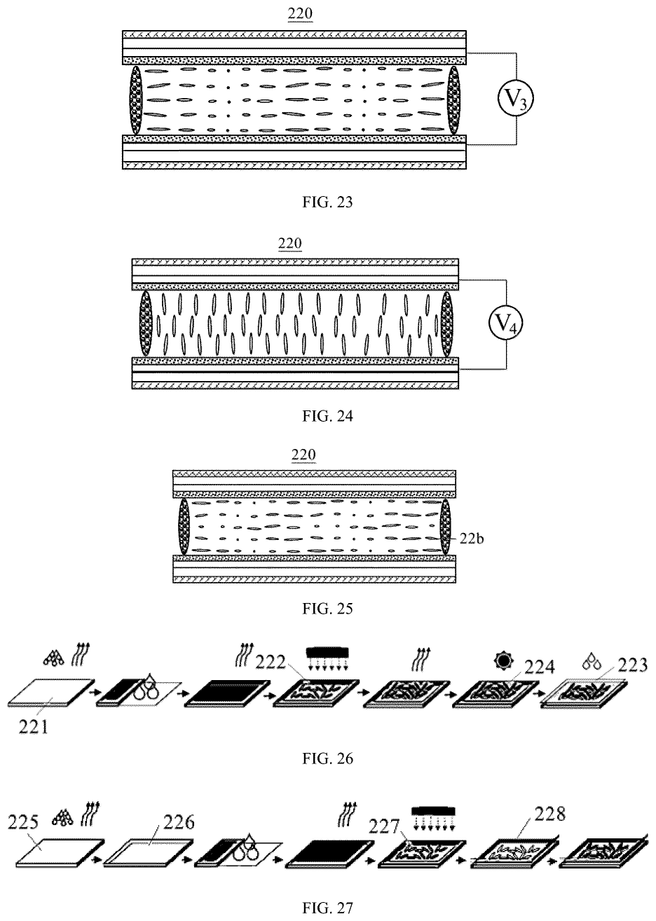

FIGS. 20-25 illustrate the schematic structure of the second optical element 220 according to this embodiment. In one embodiment, as shown in FIGS. 20 and 21, the second optical element 220 includes a third substrate 221, a third alignment layer 222, a packaging structure 223, and a second liquid crystal layer 224. The third alignment layer 222 is disposed on a side of the third substrate 221. The packaging structure 223 is disposed at the side of the third alignment layer 222 facing away from the third substrate 221. The second liquid crystal layer 224 is disposed between the packaging structure 223 and the third alignment layer 222.

Exemplarily, the second optical element 220 in FIGS. 20 and 21 can be a liquid crystal binary polarization grating. The material of the third substrate 221 can be high-transparency glass, and a thickness of the third substrate 221 can be in the range of 100 μm to 700 μm (inclusive). Since the liquid crystal orientation in the liquid crystal polarization grating periodically deflects, the third alignment layer 222 can be a photoalignment layer, and the material of the third alignment layer 222 can be azobenzene (sulfonic azo dye, SD1), polyethylene 4-methoxy cinnamate (PVMC), or photosensitive polyimide, etc. The thickness of the third alignment layer 222 can be in the range of 0.1 μm to 0.5 μm (inclusive). The packaging structure 223 can be made of materials such as silica, carbon tetrachloride, or polymethyl methacrylate (PMMA). The second optical element 220 may further include a third anti-reflection coating 22c and a fourth anti-reflection coating 22d. The third anti-reflection coating 22c is disposed on the side of the packaging structure 223 facing away from the third alignment layer 222, and the fourth anti-reflection coating 22d is disposed on the side of the third substrate 221 facing away from the third alignment layer 222. The thickness of the second liquid crystal layer 224 can be in the range of 2 μm to 5 μm (inclusive). In the case where the second optical element 220 is a single-layer nematic liquid crystal binary polarization grating (as shown in FIG. 20), the liquid crystal director in the second liquid crystal layer 224 periodically changes; in the case where the second optical element 220 is a dual-layer twisted nematic liquid crystal binary polarization grating (as shown in FIG. 21), the liquid crystal in the second liquid crystal layer 224 is helically oriented along the z-axis, requiring the addition of left-handed/right-handed chiral molecules to form a clockwise and counterclockwise helical orientation. The pitch is related to the concentration of chiral molecules added: the higher the concentration, the smaller the pitch.

After the first laser passes through the second optical element 220, it may undergo binary deflection, causing the first laser light to be deflected from the first direction to two different first deflection directions. The two first deflection directions are both different from the first direction, and the angle between the two first deflection directions and the first direction can be equal.

FIG. 26 shows a flowchart for the preparation process of the second optical element according to embodiments of the disclosure. As shown in FIGS. 20 and 26, during the preparation, the third substrate 221 is first cleaned with deionized water and dried, then covered with an azo-benzene photo-orienting material and dried. Patterned orientation is achieved using polarized light to form the third alignment layer 222. Then, liquid crystal and polymer intermediates are spin-coated multiple times. After reaching the desired thickness, ultraviolet light is used to cure the polymer and form the second liquid crystal layer 224. Finally, a packaging structure 223 is applied to block water and oxygen, completing the preparation of the second optical element 220. When the second optical element 220 is a single-layer nematic liquid crystal binary polarization grating, the liquid crystals in the second liquid crystal layer 224 are nematic liquid crystals. When the second optical element 220 is a double-layer twisted nematic liquid crystal binary polarization grating, the liquid crystals in the second liquid crystal layer 224 are arranged in a clockwise/anticlockwise helical structure with chiral polymers added.

In one embodiment, as shown in FIGS. 22 to 25, the second optical element 220 includes a fourth substrate 225, a third transparent electrode layer 226, a fourth alignment layer 227, a fifth substrate 228, a fourth transparent electrode layer 229, a fifth alignment layer 22a, and a third liquid crystal layer 22b. The third transparent electrode layer 226 is disposed on a side of the fourth substrate 225. The fourth alignment layer 227 is placed on the side of the third transparent electrode layer 226 facing away from the fourth substrate 225. The fifth substrate 228 is placed on the side of the fourth alignment layer 227 facing away from the fourth substrate 225. The fourth transparent electrode layer 229 is disposed on the side of the fifth substrate 228 facing to the fourth substrate 225. The fifth alignment layer 22a is disposed on the side of the fourth transparent electrode layer 229 facing to the fourth substrate 225. The third liquid crystal layer 22b is disposed between the fourth alignment layer 227 and the fifth alignment layer 22a. A second driving electric field is configured to be formed between the third transparent electrode layer 226 and the fourth transparent electrode layer 229. This second driving electric field is used to change the deflection state of the third liquid crystal layer 22b, deflecting the first laser light from the first direction to multiple first deflection directions.

Exemplarily, in FIGS. 22 to 25, the second optical element 220 can be a liquid crystal ternary polarization grating. The materials of the fourth substrate 225 and fifth substrate 228 can be high-transparency glass. The materials of the third transparent electrode layer 226 and fourth transparent electrode layer 229 can be ITO (Indium Tin Oxide). Depending on the preparation process, the fourth alignment layer 227 and the fifth alignment layer 22a can be rubbing alignment layers or photo-alignment layers. When the fourth alignment layer 227 and fifth alignment layer 22a are rubbing alignment layers, their materials can be PI (Polyimide); when they are photo-alignment layers, the materials can be SD1, PVMC, or photosensitive polyimide, etc. The liquid crystal director in the third liquid crystal layer 22b undergoes periodic changes. The second optical element 220 may further include a fifth anti-reflection coating 22e, a sixth anti-reflection coating 22f, and a second spacer 22g. The fifth anti-reflection coating 22e is placed on the side of the fourth substrate 225 facing away from the third transparent electrode layer 226, while the sixth anti-reflection coating 22f is placed on the side of the fifth substrate 228 facing away from the fourth transparent electrode layer 229. The second spacer 22g is disposed between the fourth alignment layer 227 and the fifth alignment layer 22a, with a diameter consistent with the cell gap, serving to support and ensure uniformity of the cell gap. The second spacer 22g may consist of frame glue mixed with polystyrene microspheres.

FIG. 27 shows a flowchart for the preparation process of the second optical element 220 according to embodiments of the disclosure. As shown in FIGS. 22 and 27, during the preparation, the fourth substrate 225 is first cleaned with deionized water and dried. Then, ITO is deposited using a magnetron sputtering process to form the third transparent electrode layer 226. Next, SD1 is spin-coated, dried, and patterned by polarized light for alignment. The prepared structure is then aligned with a structure including a fifth substrate 228 and the fourth transparent electrode layer 229 deposited on the fifth substrate 228, ensuring that the third transparent electrode layer 226 and the fourth transparent electrode layer 229 are positioned oppositely. The second spacer 22g determines the liquid crystal cell gap. Afterward, the liquid crystal is vacuum-injected to form the third liquid crystal layer 22b, and finally, the structure is sealed, completing the preparation of the second optical element 220. When the second optical element 220 is a single-layer nematic liquid crystal polarization grating, the liquid crystals in the third liquid crystal layer 22b are nematic liquid crystals. When the second optical element 220 is a dual-layer twisted nematic liquid crystal polarization grating, the liquid crystals in the third liquid crystal layer 22b are liquid crystals in a clockwise/anticlockwise helical arrangement with added chiral polymers.

The thickness of each of the fourth substrate 225 and fifth substrate 228 can range from 100 μm to 700 μm (including endpoint values). The thickness of each of the third transparent electrode layer 226 and the fourth transparent electrode layer 229 can range from 0.05 μm to 2 μm (including endpoint values). The thickness of each of the fourth alignment layer 227 and the fifth alignment layer 22a can range from 0.01 μm to 0.5 μm (including endpoint values). The thickness of the third liquid crystal layer 22b can range from 2 μm to 5 μm (including endpoint values). The thickness of each of the fifth anti-reflection coating 22e and the sixth anti-reflection coating 22f can range from 0.2 μm to 1 μm (including endpoint values).

When a voltage V3=0 V is applied between the third transparent electrode layer 226 and the fourth transparent electrode layer 229, the liquid crystal director changes periodically along the X direction. In this case, the first laser light entering the second optical element 220 undergoes deflection. A deflection angle is related to the period of the liquid crystal polarization grating, where the smaller the grating period, the larger the deflection angle. When a saturation voltage V4 is applied between the third transparent electrode layer 226 and the fourth transparent electrode layer 229, a second driving electric field is configured to be formed between the third transparent electrode layer 226 and the fourth transparent electrode layer 229. The liquid crystal director rearranges along the direction of the second driving electric field, and the liquid crystal molecules in the third liquid crystal layer 22b are uniformly aligned along the Y-axis. In this case, the second optical element 220 has no deflection effect on the first laser light.

After the first laser light passes through the second optical element 220, it undergoes ternary deflection, with the first laser light deflected from the first direction to three different first deflection directions. One of the first deflection directions is the same as the first direction, while the other two first deflection directions are different from the first direction, with the angle between the two deflection directions being equal.

The second optical element 220 can be a single-layer nematic liquid crystal ternary polarization grating or a dual-layer twisted nematic liquid crystal ternary polarization grating. In the case of the second optical element 220 being a dual-layer twisted nematic liquid crystal ternary polarization grating, chiral molecules are added to the nematic liquid crystal to achieve a clockwise/anticlockwise helical distribution of the liquid crystal along the Z-axis in the third liquid crystal layer 22b.

Next, the simulation results of the first scanner provided in embodiments of the disclosure will be introduced.

Taking the wavelength of the incident light as 940 nm (nanometers) as an example, the simulation results for the first scanner, including a liquid crystal binary polarization grating (i.e., the second optical element being a liquid crystal binary polarization grating, and the second optical element being either a single-layer nematic liquid crystal binary polarization grating or a dual-layer twisted nematic liquid crystal binary polarization grating), will be introduced.

### (1) First Simulation Structure of the First Scanner

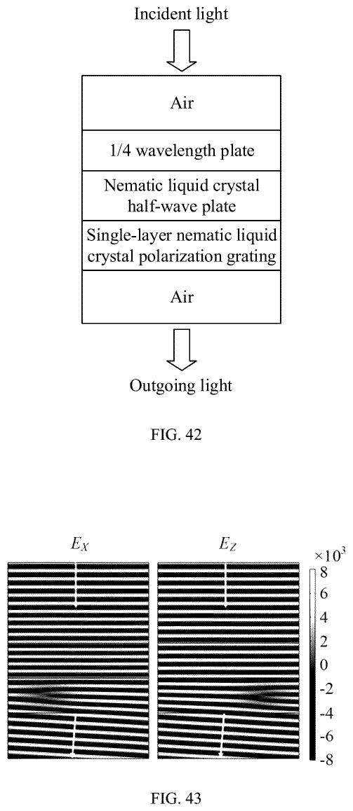

The schematic diagram of the first simulation structure of the first scanner is shown in FIG. 42. In this structure, the first optical element is a ¼ wave plate, the second optical element is a single-layer nematic liquid crystal polarization grating and is a single-layer nematic liquid crystal binary polarization grating, and the third optical element is a single-layer nematic liquid crystal half-wave plate.

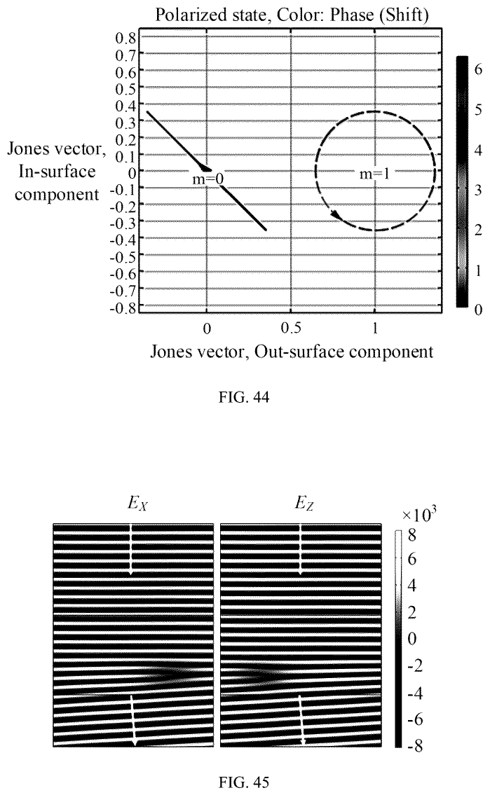

The electric field distribution diagram when a voltage of V1=0 V is applied between the first and second transparent electrode layers of the nematic liquid crystal half-wave plate, and a voltage of V3=0 V is applied between the third and fourth transparent electrode layers of the single-layer nematic liquid crystal polarization grating, is shown in FIG. 43, with the beam deflecting by 5°. The polarization conversion diagram for linearly polarized incident light and circularly polarized outgoing light when a voltage of V1=0 V is applied to the nematic liquid crystal half-wave plate and a voltage of V3=0 V is applied to the single-layer nematic liquid crystal polarization grating is shown in FIG. 44. The incident light is linearly polarized light, which is converted into right-handed circularly polarized light by the ¼ wave plate. Then, it passes through the nematic liquid crystal half-wave plate and is converted into left-handed circularly polarized light. In this case, the left-handed circularly polarized light undergoes positive first order diffraction when passing through the single-layer nematic liquid crystal polarization grating, resulting in outgoing light with a 5° deflection, and finally, right-handed circularly polarized light is emitted.

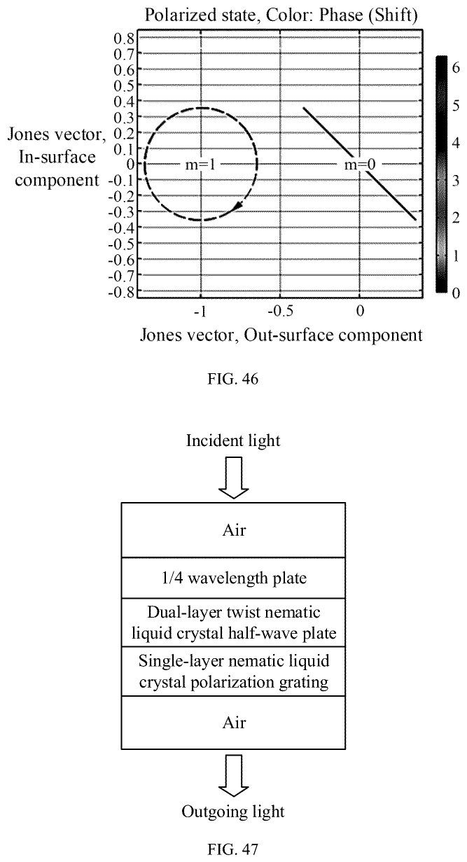

When a saturation voltage V2 is applied between the first and second transparent electrode layers of the nematic liquid crystal half-wave plate, and a voltage of V3=OV is applied between the third and fourth transparent electrode layers of the single-layer nematic liquid crystal polarization grating, the electric field distribution diagram is shown in FIG. 45, with the beam deflecting by −5°. The polarization conversion diagram for linearly polarized incident light and circularly polarized outgoing light when a saturation voltage V2 is applied to the nematic liquid crystal half-wave plate and a voltage of V3=0 V is applied to the single-layer nematic liquid crystal polarization grating is shown in FIG. 46. The incident light is linearly polarized light, which is converted into right-handed circularly polarized light by the ¼ wave plate. The nematic liquid crystal half-wave plate with the saturation voltage does not change the polarization state of the light. In this case, right-handed circularly polarized light undergoes—negative first order diffraction when passing through the single-layer nematic liquid crystal polarization grating, resulting in outgoing light with a −5° deflection, and finally, left-handed circularly polarized light is emitted.

### (2) Second Simulation Structure of the First Scanner

The schematic diagram of the second simulation structure of the first scanner is shown in FIG. 47. In this structure, the first optical element is a ¼ wave plate, the second optical element is a single-layer nematic liquid crystal polarization grating and is a single-layer nematic liquid crystal binary polarization grating, and the third optical element is a dual-layer twisted nematic liquid crystal half-wave plate.

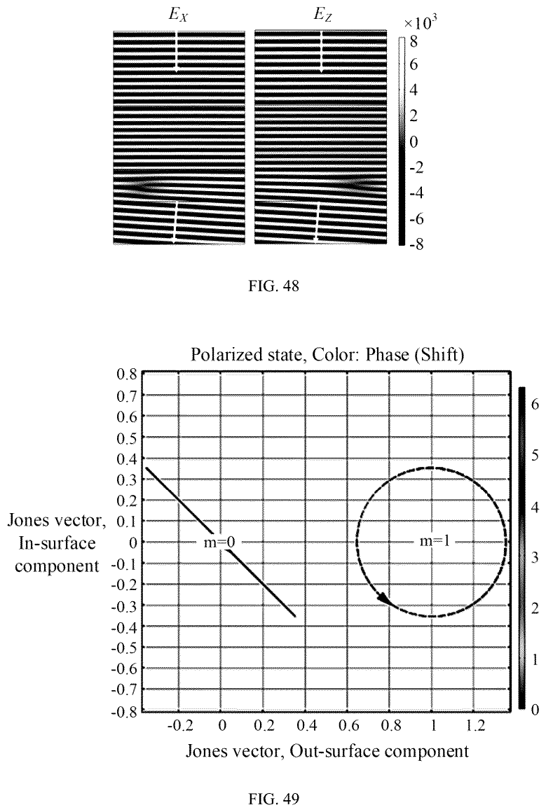

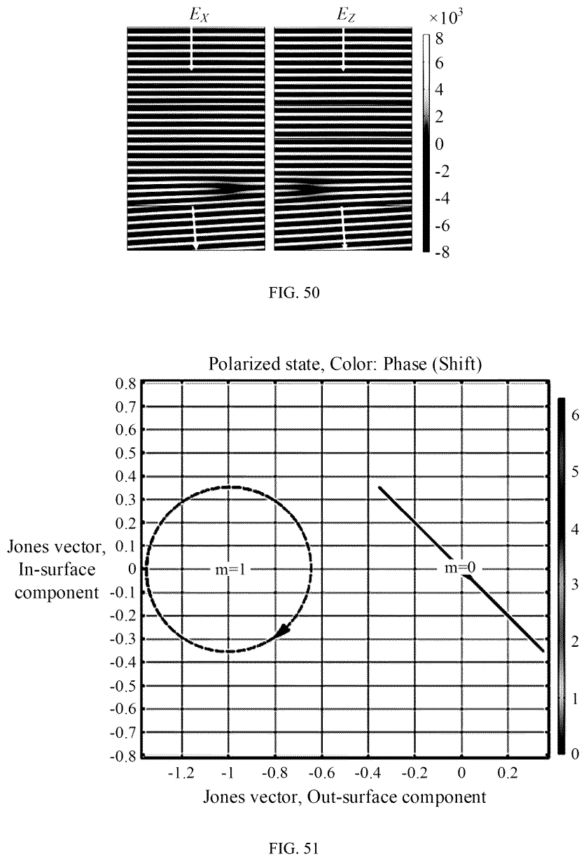

The electric field distribution diagram when a voltage of V1=0 V is applied between the first and second transparent electrode layers of the dual-layer twisted nematic liquid crystal half-wave plate, and a voltage of V3=0 V is applied between the third and fourth transparent electrode layers of the single-layer nematic liquid crystal polarization grating, is shown in FIG. 48, with the beam deflecting by 5°. The polarization conversion diagram for linearly polarized incident light and circularly polarized outgoing light when a voltage of V1=0 V is applied to the dual-layer twisted nematic liquid crystal half-wave plate and a voltage of V3=OV is applied to the single-layer nematic liquid crystal polarization grating is shown in FIG. 49. The incident light is linearly polarized light, which is converted into right-handed circularly polarized light by the ¼ wave plate. Then, it passes through the dual-layer twisted nematic liquid crystal half-wave plate and is converted into left-handed circularly polarized light. In this case, the left-handed circularly polarized light undergoes+positive first order diffraction when passing through the single-layer nematic liquid crystal polarization grating, resulting in outgoing light with a 5° deflection, and finally, right-handed circularly polarized light is emitted.

When a saturation voltage V2 is applied between the first and second transparent electrode layers of the dual-layer twisted nematic liquid crystal half-wave plate, and a voltage of V3=0 V is applied between the third and fourth transparent electrode layers of the single-layer nematic liquid crystal polarization grating, the electric field distribution diagram is shown in FIG. 50, with the beam deflecting by −5°. The polarization conversion diagram for linearly polarized incident light and circularly polarized outgoing light when a saturation voltage V2 is applied to the dual-layer twisted nematic liquid crystal half-wave plate and a voltage of V3=0 V is applied to the single-layer nematic liquid crystal polarization grating is shown in FIG. 51. The incident light is linearly polarized light, which is converted into right-handed circularly polarized light by the ¼ wave plate. The dual-layer twisted nematic liquid crystal half-wave plate with the saturation voltage does not change the polarization state of the light. In this case, right-handed circularly polarized light undergoes first order diffraction when passing through the single-layer nematic liquid crystal polarization grating, resulting in outgoing light with a −5° deflection, and finally, left-handed circularly polarized light is emitted.

### (3) Third Simulation Structure of the First Scanner

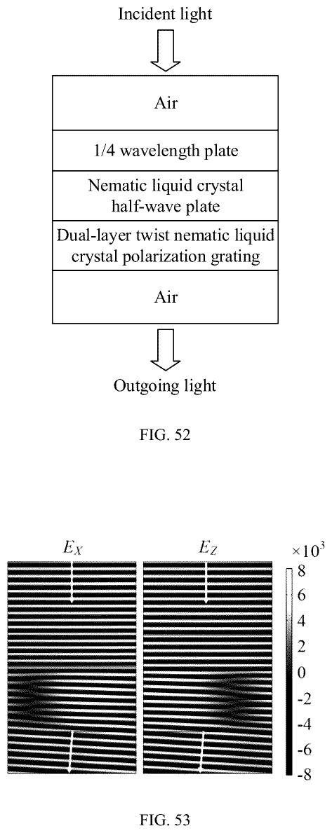

The schematic diagram of the third simulation structure of the first scanner is shown in FIG. 52. In this structure, the first optical element is a ¼ wave plate, the second optical element is a dual-layer twisted nematic liquid crystal polarization grating and is a dual-layer twisted nematic liquid crystal binary polarization grating, and the third optical element is a single-layer nematic liquid crystal half-wave plate.

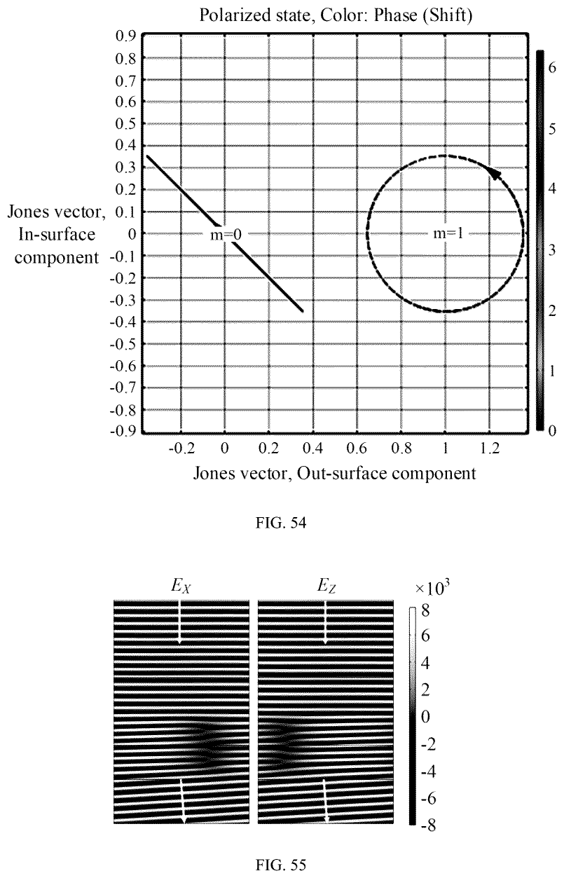

The electric field distribution diagram when a voltage of V1=0 V is applied between the first and second transparent electrode layers of the nematic liquid crystal half-wave plate, and a voltage of V3=0 V is applied between the third and fourth transparent electrode layers of the dual-layer twisted nematic liquid crystal polarization grating, is shown in FIG. 53, with the beam deflecting by 5°. The polarization conversion diagram for linearly polarized incident light and circularly polarized outgoing light when a voltage of V1=0 V is applied to the nematic liquid crystal half-wave plate and a voltage of V3=0 V is applied to the dual-layer twisted nematic liquid crystal polarization grating is shown in FIG. 54. The incident light is linearly polarized light, which is converted into right-handed circularly polarized light by the ¼ wave plate. Then, it passes through the nematic liquid crystal half-wave plate and is converted into left-handed circularly polarized light. In this case, the left-handed circularly polarized light undergoes first order diffraction when passing through the dual-layer twisted nematic liquid crystal polarization grating, resulting in outgoing light with a 5° deflection, and finally, right-handed circularly polarized light is emitted.

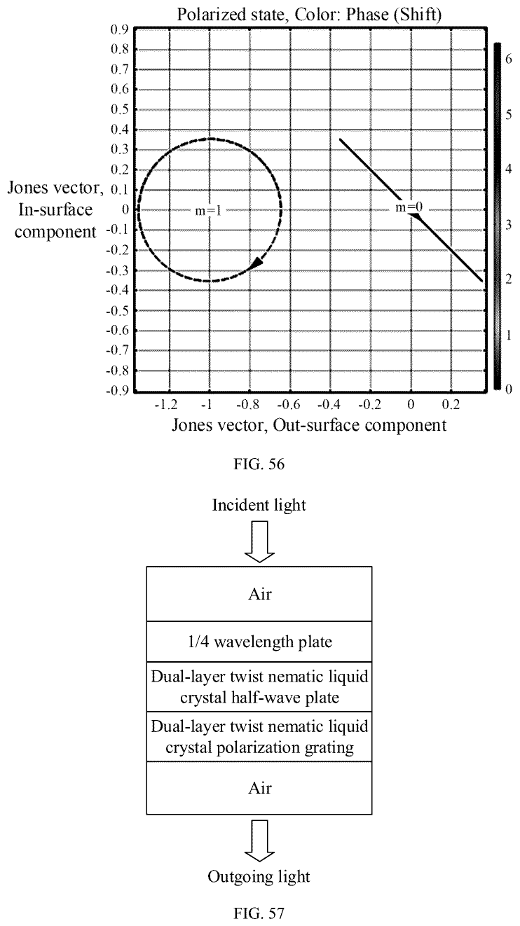

When a saturation voltage V2 is applied between the first and second transparent electrode layers of the nematic liquid crystal half-wave plate, and a voltage of V3=OV is applied between the third and fourth transparent electrode layers of the dual-layer twisted nematic liquid crystal polarization grating, the electric field distribution diagram is shown in FIG. 55, with the beam deflecting by −5°. The polarization conversion diagram for linearly polarized incident light and circularly polarized outgoing light when a saturation voltage V2 is applied to the nematic liquid crystal half-wave plate and a voltage of V3=0 V is applied to the dual-layer twisted nematic liquid crystal polarization grating is shown in FIG. 56. The incident light is linearly polarized light, which is converted into right-handed circularly polarized light by the ¼ wave plate. The nematic liquid crystal half-wave plate with the saturation voltage does not change the polarization state of the light. In this case, the right-handed circularly polarized light undergoes negative first order diffraction when passing through the dual-layer twisted nematic liquid crystal polarization grating, resulting in a −5° deflection, and finally, left-handed circularly polarized light is emitted.

### (4) Fourth Simulation Structure of the First Scanner

The schematic diagram of the fourth simulation structure of the first scanner is shown in FIG. 57. In this structure, the first optical element is a ¼ wave plate, the second optical element is a dual-layer twisted nematic liquid crystal polarization grating and is a dual-layer twisted nematic liquid crystal binary polarization grating, and the third optical element is a dual-layer twisted nematic liquid crystal half-wave plate.

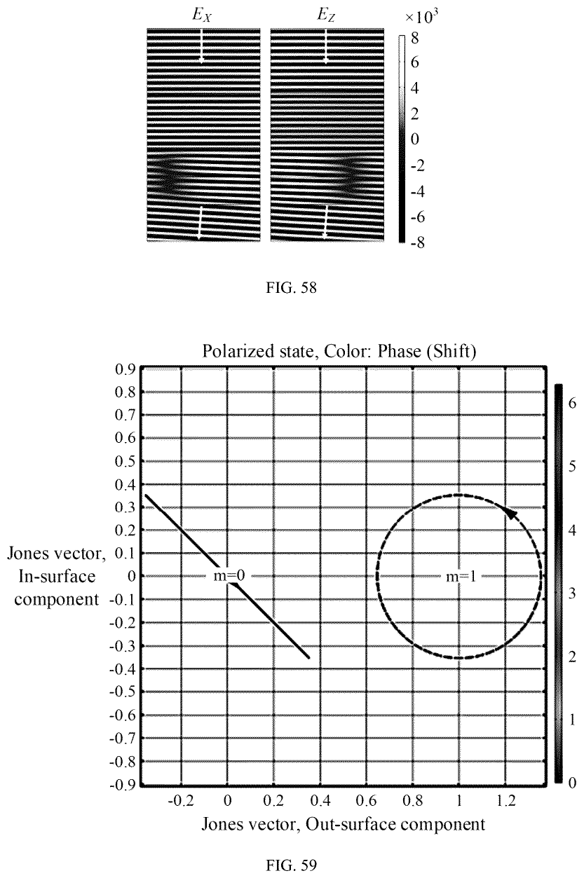

The electric field distribution diagram when a voltage of V1=0 V is applied between the first and second transparent electrode layers of the dual-layer twisted nematic liquid crystal half-wave plate, and a voltage of V3=0 V is applied between the third and fourth transparent electrode layers of the dual-layer twisted nematic liquid crystal polarization grating, is shown in FIG. 58, with the beam deflecting by 5°. The polarization conversion diagram for linearly polarized incident light and circularly polarized outgoing light when a voltage of V1=0 V is applied to the dual-layer twisted nematic liquid crystal half-wave plate and a voltage of V3=0 V is applied to the dual-layer twisted nematic liquid crystal polarization grating is shown in FIG. 59. The incident light is linearly polarized light, which is converted into right-handed circularly polarized light by the ¼ wave plate. Then, it passes through the dual-layer twisted nematic liquid crystal half-wave plate and is converted into left-handed circularly polarized light. In this case, the left-handed circularly polarized light undergoes positive first order diffraction when passing through the dual-layer twisted nematic liquid crystal polarization grating, resulting in outgoing light with a 5° deflection, and finally, right-handed circularly polarized light is emitted.

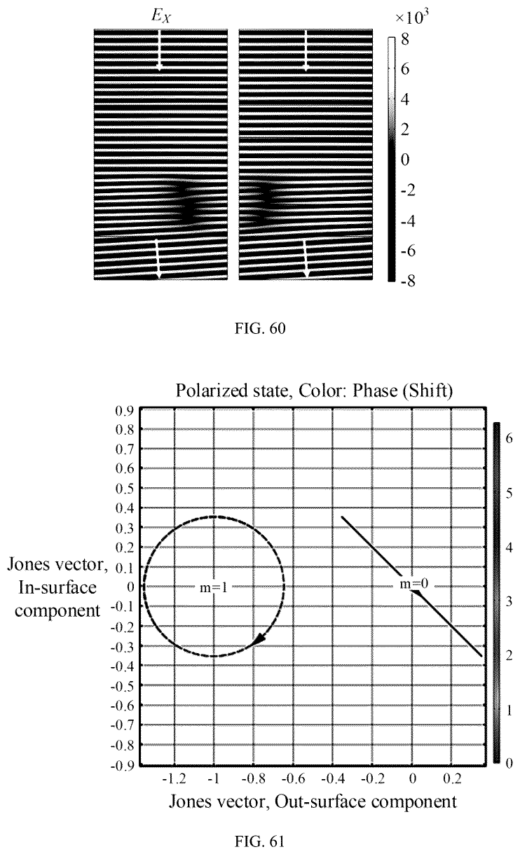

When a saturation voltage V2 is applied between the first and second transparent electrode layers of the dual-layer twist nematic liquid crystal half-wave plate, and a voltage V3=0 V is applied between the third and fourth transparent electrode layers of the dual-layer twist nematic liquid crystal polarization grating, the electric field distribution is shown in FIG. 60, and the light beam is deflected by −5°. When a saturation voltage V2 is applied to the dual-layer twist nematic liquid crystal half-wave plate and a voltage V3=0 V is applied to the dual-layer twist nematic liquid crystal polarization grating, the polarization conversion diagram for the linearly polarized incident light and the circularly polarized outgoing light is shown in FIG. 61. The incident light is linerly polarized light, which is converted to right-handed circularly polarized light by the ¼ wave plate. When the saturation voltage V2 is applied to the dual-layer twist nematic liquid crystal half-wave plate, it does not change the polarization state of the light. In this case, the right-handed circularly polarized light undergoes negative first order diffraction through the dual-layer twist nematic liquid crystal polarization grating, the outgoing light is deflected by −5°, and finally, left-handed circularly polarized light is emitted.

Taking the incident light wavelength as 940 nm as an example, the simulation results of the first scanner including a liquid crystal ternary polarization grating (i.e., the second optical element is a liquid crystal ternary polarization grating, and the second optical element is either a single-layer nematic liquid crystal ternary polarization grating or a dual-layer twist nematic liquid crystal ternary polarization grating) are introduced. In addition to the full-wave results of the first scanner simulation that includes a liquid crystal binary polarization grating, there is also the case where the liquid crystal polarization grating is applied with a saturation voltage, resulting in a 0° deflection.

### (5) Fifth Simulation Structure of the First Scanner

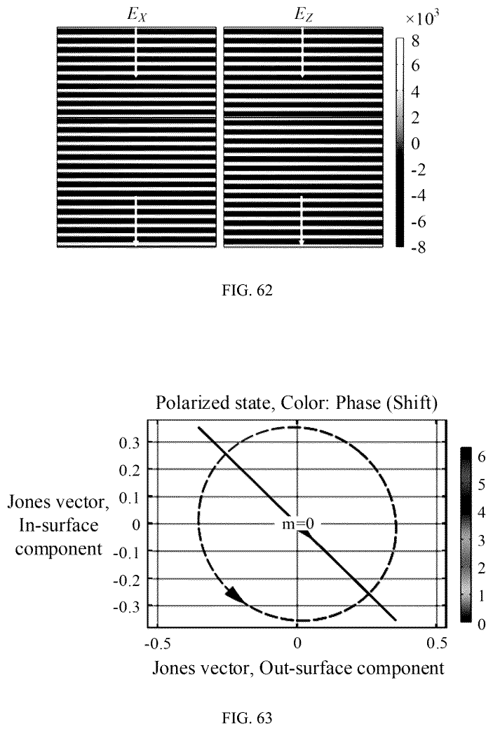

The schematic of the fifth simulation structure of the first scanner is shown in FIG. 62. In this simulation structure of the first scanner, the first optical element is a ¼ wave plate, the second optical element is a single-layer nematic liquid crystal polarization grating, which is a single-layer nematic liquid crystal ternary polarization grating, and the third optical element is a single-layer nematic liquid crystal half-wave plate.

When a saturation voltage V2 is applied between the first and second transparent electrode layers of the single-layer nematic liquid crystal half-wave plate and a saturation voltage V4 is applied between the third and fourth transparent electrode layers of the single-layer nematic liquid crystal polarization grating, the electric field distribution is shown in FIG. 62, and the light beam is deflected by 0°. When a saturation voltage V2 is applied to the single-layer nematic liquid crystal half-wave plate and a saturation voltage V4 is applied to the single-layer nematic liquid crystal polarization grating, the polarization conversion diagram for the linearly polarized incident light and the circularly polarized outgoing light is shown in FIG. 63. The incident light is linerly polarized light, which is converted to right-handed circularly polarized light by the ¼ wave plate. When the saturation voltage V2 is applied, the nematic liquid crystal half-wave plate does not alter the polarization state. In this case, the right-handed circularly polarized light undergoes 0 order diffraction through the single-layer nematic liquid crystal polarization grating applied with the saturation voltage V4, the outgoing light has a deflection angle of 0°, the polarization state is not changed, and finally, right-handed circularly polarized light is emitted.

### (6) Sixth Simulation Structure of the First Scanner

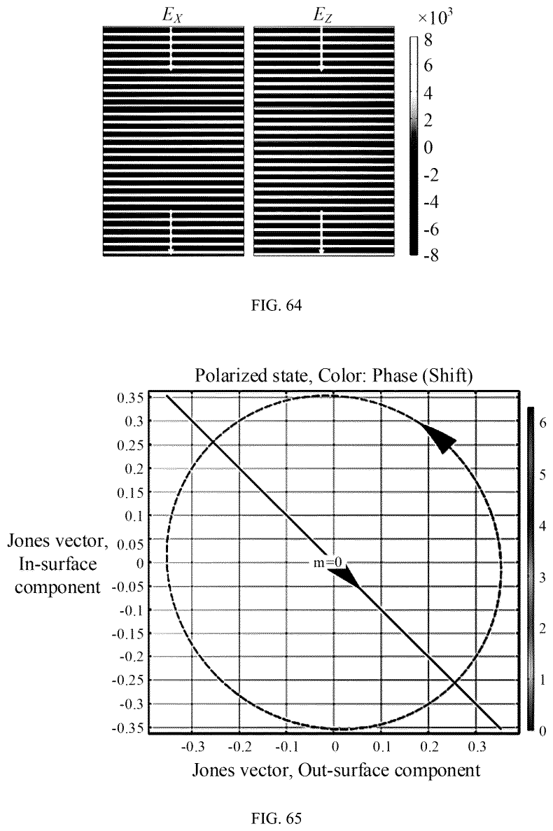

The schematic of the sixth simulation structure of the first scanner is shown in FIG. 64. In this simulation structure of the first scanner, the first optical element is a ¼ wave plate, the second optical element is a single-layer nematic liquid crystal polarization grating, which is a single-layer nematic liquid crystal ternary polarization grating, and the third optical element is a dual-layer twist nematic liquid crystal half-wave plate.

When a saturation voltage V2 is applied between the first and second transparent electrode layers of the dual-layer twist nematic liquid crystal half-wave plate and a saturation voltage V4 is applied to the third and fourth transparent electrode layers of the single-layer nematic liquid crystal polarization grating, the electric field distribution is shown in FIG. 64, and the beam is deflected by 0°. When the saturation voltage V2 is applied to the dual-layer twist nematic liquid crystal half-wave plate and the saturation voltage V4 is applied to the single-layer nematic liquid crystal polarization grating, the polarization conversion diagram for the linearly polarized incident light and the circularly polarized outgoing light is shown in FIG. 65. The incident light is linerly polarized light, which is converted to right-handed circularly polarized light by the ¼ wave plate. When the saturation voltage V2 is applied, the dual-layer twist nematic liquid crystal half-wave plate does not alter the polarization state. In this case, the right-handed circularly polarized light undergoes 0 order diffraction through the single-layer nematic liquid crystal polarization grating applied with the saturation voltage V4, the outgoing light has a deflection angle of 0°, the polarization state is not changed, and finally, right-handed circularly polarized light is emitted.

### (7) Seventh Simulation Structure of the First Scanner

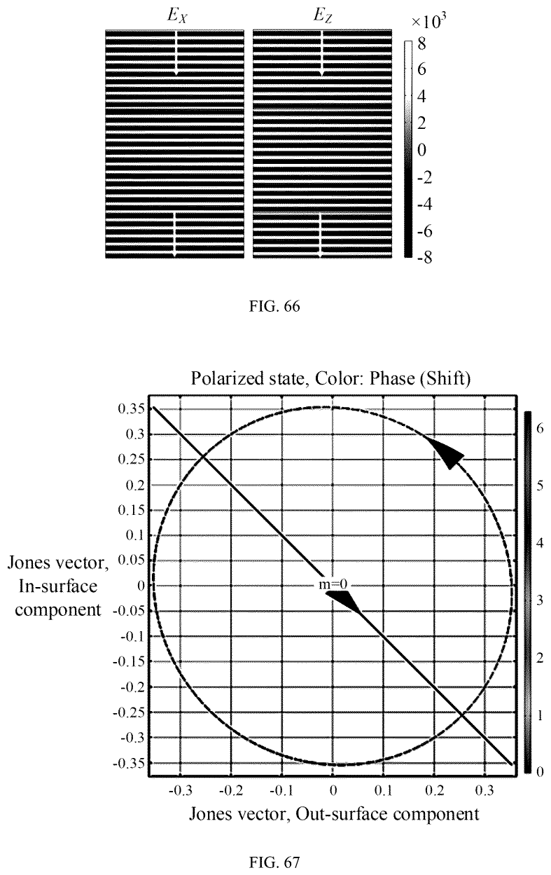

The schematic of the seventh simulation structure of the first scanner is shown in FIG. 66. In this simulation structure of the first scanner, the first optical element is a ¼ wave plate, the second optical element is a single-layer nematic liquid crystal polarization grating, which is a dual-layer twist nematic liquid crystal ternary polarization grating, and the third optical element is a single-layer nematic liquid crystal half-wave plate.

When a saturation voltage V2 is applied between the first and second transparent electrode layers of the nematic liquid crystal half-wave plate and a saturation voltage V4 is applied to the third and fourth transparent electrode layers of the dual-layer twist nematic liquid crystal polarization grating, the electric field distribution is shown in FIG. 66, and the beam is deflected by 0°. When a saturation voltage V2 is applied to the nematic liquid crystal half-wave plate and a saturation voltage V4 is applied to the dual-layer twist nematic liquid crystal polarization grating, the polarization conversion diagram for the linearly polarized incident light and the circularly polarized outgoing light is shown in FIG. 67. The incident light is linerly polarized light, which is converted to right-handed circularly polarized light by the ¼ wave plate. When the saturation voltage V2 is applied, the nematic liquid crystal half-wave plate does not alter the polarization state. In this case, the right-handed circularly polarized light undergoes 0 order diffraction through the dual-layer twist nematic liquid crystal polarization grating applied with saturation voltage V4, the outgoing light has a deflection angle of 0°, the polarization state is not changed, and finally, right-handed circularly polarized light is emitted.

### (8) Eighth Simulation Structure of the First Scanner

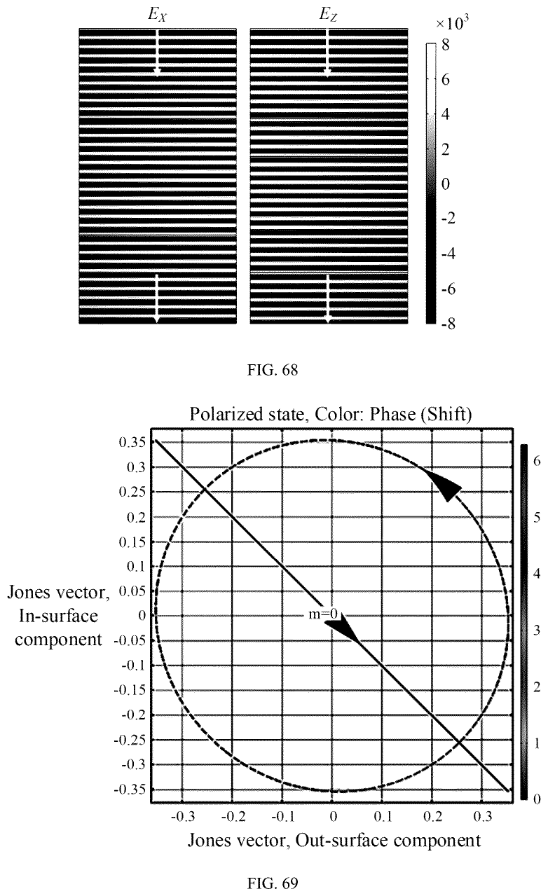

The schematic of the eighth simulation structure of the first scanner is shown in FIG. 68. In this simulation structure of the first scanner, the first optical element is a ¼ wave plate, the second optical element is a dual-layer nematic liquid crystal polarization grating, which is a dual-layer twist nematic liquid crystal ternary polarization grating, and the third optical element is a dual-layer twist nematic liquid crystal half-wave plate.

When a saturation voltage V2 is applied between the first and second transparent electrode layers of the dual-layer twist nematic liquid crystal half-wave plate and a saturation voltage V4 is applied between the third and fourth transparent electrode layers of the dual-layer twist nematic liquid crystal polarization grating, the electric field distribution is shown in FIG. 68, and the beam is deflected by 0°. When a saturation voltage V2 is applied to the dual-layer twist nematic liquid crystal half-wave plate and a saturation voltage V4 is applied to the dual-layer twist nematic liquid crystal polarization grating, the polarization conversion diagram for the linearly polarized incident light and the circularly polarized outgoing light is shown in FIG. 69. The incident light is linerly polarized light, which is converted to right-handed circularly polarized light by the ¼ wave plate. When the saturation voltage V2 is applied, the dual-layer twist nematic liquid crystal half-wave plate does not alter the polarization state. In this case, the right-handed circularly polarized light undergoes 0 order diffraction through the dual-layer twist nematic liquid crystal polarization grating applied with the saturation voltage V4, the outgoing light has a deflection angle of 0°, the polarization state is not changed, and finally, right-handed circularly polarized light is emitted.

It should be noted that in FIGS. 43, 45, 48, 50, 53, 55, 58, 60, 62, 64, 66, and 68, the polarized light propagates along the z-axis, reference sign Ex indicates a component of the electric field of the polarized light along the x-axis, reference sign Ez indicates a component of the electric field of the polarized light along the z-axis, and in FIGS. 44, 46, 49, 51, 54, 56, 59, 61, 63, 65, 67, and 69, reference sign m represents the diffraction order.

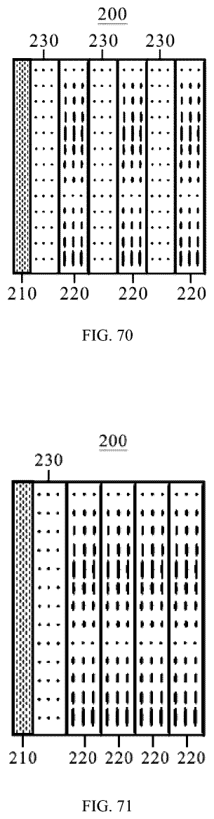

In one embodiment, as shown in FIGS. 70 and 71, the first scanner 200 includes N second optical elements 220. The N second optical elements are arranged sequentially on the side of the first optical element facing away from the transmitter. Here, N is an integer greater than 1.

It should be noted that in FIGS. 70 and 71, N=4 is used as an example. In practical implementations, the value of N can be selected based on actual requirements.

In one embodiment, polarization directions of the N second optical elements are different. A ratio of a deflection angle of the j-th one of second optical elements to a deflection angle of a first one of the second optical elements is an integer greater than 1. Here, j is an integer greater than 1 and less than or equal to N. The first one of the second optical elements is a second optical element closest to the first optical element among the N second optical elements.

In some embodiments, the deflection angle of the j-th one of second optical elements is greater than a deflection angle of the (j-1)-th one of the second optical elements.

In one embodiment, as shown in FIG. 70, the first scanner 200 includes N third optical elements 230. The third optical elements 230 and the second optical elements 220 are alternately arranged on the side of the first optical element 210 facing away from the transmitter. The first one of the N third optical elements 230 is disposed between the first one of the second optical elements 220 and the first optical element 210.

For the first scanner 200 shown in FIG. 70, the first laser light emitted from the transmitter first enters the first optical element 210, is converted from the linear polarization state to the circular polarization state via the first optical element 210, and then enters the first one of the third optical elements 230. After passing through the first one of the third optical elements 230, the left-handed circular polarization state is converted to the right-handed circular polarization state, or the right-handed circular polarization state is converted to the left-handed polarization state, or the current circular polarization state is maintained. The first laser light then enters the first one of the second optical elements 220, the angle being deflected, and enters the second one of the third optical elements 230. The second one of the third optical elements 230 can convert the left-handed circular polarization state to the right-handed circular polarization state, or convert the right-handed circular polarization state to the left-handed polarization state, or maintain the current circular polarization state. The first laser light then enters the second one of the second optical elements 220, the angle being deflected, and enters the next one of the third optical elements 230. The effect of each third optical element 230 is the same, and the effect of each second optical element 220 is the same, which will not be repeated here. The last one of the second optical elements 220 emits the first laser along multiple first deflection directions.

In practical implementations, the final deflection angle(s) of the outgoing light can be controlled by applying or not applying the saturation voltage to the first optical element, each second optical element, and each third optical element.

In one embodiment, in the first scanner 200 shown in FIG. 70, the deflection angles of the four second optical elements 220 in the direction far away from the first optical element 210 are 1.3°, 2.6°, 5.2°, and 10.4°, respectively.

Alternatively, in one embodiment, as shown in FIG. 71, the first scanner includes one third optical element 230, and the N second optical elements 220 are arranged sequentially on the side of the third optical element 230 facing away from the first optical element 210.

For the first scanner 200 shown in FIG. 71, the first laser light emitted from the transmitter first enters the first optical element 210. After the first optical element 210 converts the linear polarization state to the circular polarization state, the first laser light enters the third optical element 230. After passing through the third optical element 230, the left-handed circular polarization state is converted to the right-handed circular polarization state, or the right-handed circular polarization state is converted to the left-handed polarization state, or the current circular polarization state is maintained. The first laser light then sequentially enters the first one to the N-th one of the second optical elements 220, and the angle is deflected. The last one of the second optical elements 220 emits the first laser along multiple first deflection directions.

In practical implementations, the final deflection angle of the outgoing light can be controlled by applying or not applying the saturation voltage to the first optical element, each second optical element, and the third optical element.

In one embodiment, in the first scanner 200 shown in FIG. 71, the deflection angles of the four second optical elements 220 in the direction far away from the first optical element 210 are 1.3°, 3.9°, 9.1°, and 10.4°, respectively.

In one embodiment, the number of pointing angles of the first scanner is 2N+1-1.

In one embodiment, the LiDAR assembly 10 further includes a transmitting optical component. The input terminal of the transmitting optical component is arranged facing to the output terminal of the first scanner 200. The first laser light along multiple first deflection directions is transmitted to the target object 20 through the transmitting optical component. This ensures that the first laser light, with equivalent number of channels being enhanced by the first scanner 200, can be correctly transmitted to the target object 20.

It should be noted that directions of the first laser light along multiple first deflection directions may change after passing through the transmitting optical component, so the directions of the first laser light emitted to the target object 20 may not exactly the multiple first deflection directions.

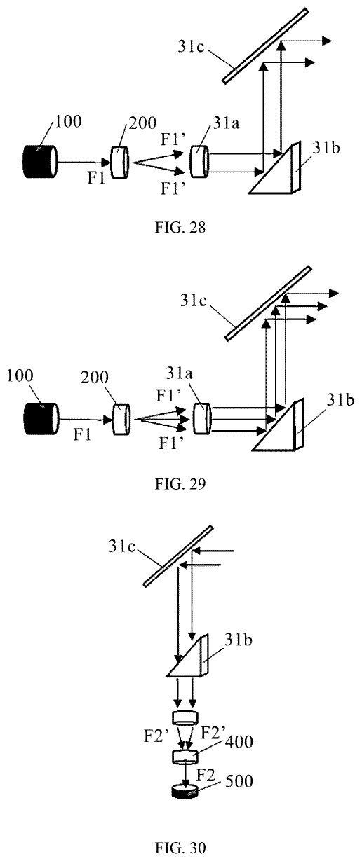

FIGS. 28 and 29 show schematic diagrams illustrating laser emission of the LiDAR assembly according to a first embodiment of the disclosure. In one implementation, referring to FIGS. 28 and 29, the transmitting optical component includes a first collimating lens 31a, a first prism 31b, and a first mirror 31c arranged in sequence along the optical path of the first laser light. The first mirror 31c is used to emit the first laser light to the target object.

For example, the LiDAR assembly can be a mechanical LiDAR assembly. The transmitter 100 emits laser light, which is deflected by the first scanner 200 from the first direction F1 to multiple different first deflection directions F1′, achieving fine laser scanning. For example, when the first scanner 200 includes a liquid crystal binary polarization grating, the first scanner 200 can deflect the first laser light from the first direction F1 to two different first deflection directions F1′. When the first scanner 200 includes a liquid crystal ternary polarization grating, the first scanner 200 can deflect the first laser light from the first direction F1 to three different first deflection directions F1′. The first laser light emitted from the first scanner 200 is collimated and focused by the first collimating lens 31a, reflected by the first prism 31b, and then reflected by the rotating first mirror 31c, which directs the first laser light to the target object. The first mirror 31c serves as the scanning module 700 described earlier.

FIGS. 32 and 33 show schematic diagram illustrating laser emission and laser reception of the LiDAR assembly according to a second embodiment of the disclosure. In one implementation, referring to FIGS. 32 and 33, the transmitting optical component can include a second collimating lens 31d, a second mirror 31e, and a rotating mirror 31f mounted on a rotation shaft 31g arranged in sequence in the light path of the first laser light. The rotating mirror 31f is used to direct the first laser light to the target object 20.

For example, the LiDAR component can be a rotating mirror LiDAR assembly. The transmitter 100 emits laser light, which passes through the first scanner 200, where the first laser light along the first direction F1 is deflected into multiple different first deflection directions F1′, enabling fine laser scanning. The first laser light emitted from the first scanner 200 is focused and collimated by the second collimating lens 31d, then reflected by the second mirror 31e to the rotating mirror 31f, which rotates around the rotation shaft 31g. The rotating mirror 31f then directs the first laser light towards the target object 20. The rotating mirror 31f serves as the scanning module 700 as mentioned above.

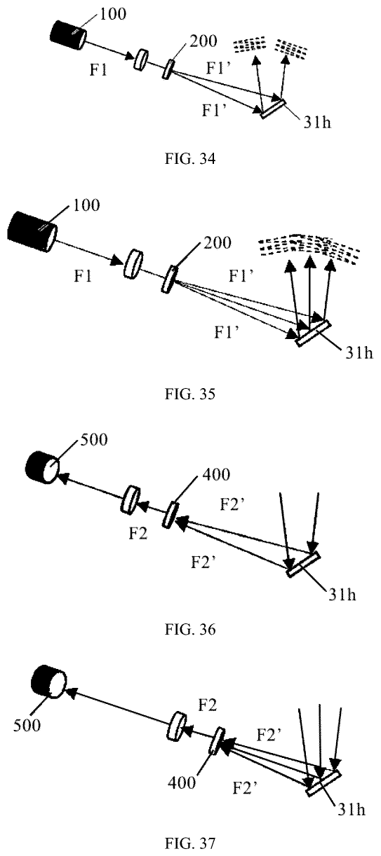

FIGS. 34 and 35 show the schematic diagram illustrating laser emission of the LIDAR assembly according to a third embodiment of the disclosure. In one embodiment, with reference to FIGS. 34 and 35, the transmitting optical component includes a resonance mirror 31h, which is used to direct the first laser light towards the target object. For example, the LIDAR assembly can be a MEMS LIDAR assembly. The transmitter 100 emits the laser light, which, after being collimated by the collimating lens, enters the first scanner 200 for binary or ternary deflection to produce the first laser light along multiple first deflection directions F1′. Finally, the resonance mirror 31h, such as a MEMS mirror, directs the first laser light towards the target object. The resonance mirror 31h serves as the scanning module 700 as mentioned above.

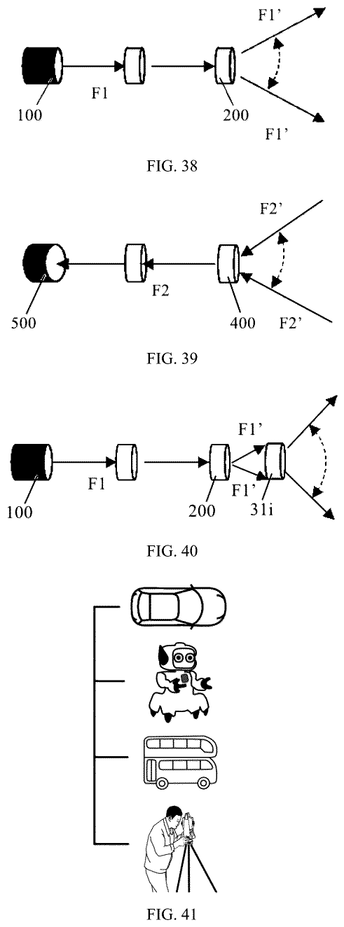

FIG. 38 shows the schematic diagram illustrating laser emission of the LiDAR assembly according to a fourth embodiment the disclosure. As shown in FIG. 38, the LiDAR assembly 10 can be a FLASH LIDAR assembly 10. The transmitter 100 emits the laser light, which, after being focused and collimated by the collimating lens, enters the first scanner 200 for binary or ternary deflection, obtaining the first laser light along multiple first deflection directions F1′. Compared to the LiDAR assembly 10 shown in FIG. 6, the first scanner 200 can replace the diverging lens to realize the electronic deflection of the first laser light, significantly increasing the laser power per unit area, thereby improving the detection range of the LiDAR assembly 10.

FIG. 40 shows the schematic diagram illustrating laser emission of the LiDAR assembly according to a fifth embodiment the disclosure. In one implementation, as shown in FIG. 40, the transmitting optical component includes a diverging lens 31i, which is used to direct the first laser light towards the target object. For example, the first scanner 200 can be disposed between the collimating lens and the diverging lens 31i. This arrangement can further increase the field of view of the LiDAR assembly 10, allowing the LiDAR assembly 10 to have both long-range and wide field-of-view performance, while simultaneously improving the laser power per unit area.

In one embodiment, the LiDAR assembly 10 further includes: a second scanner 400 and a receiver 500. The receiver 500 is configured to receive the laser light reflected by the target object 20 and convert the optical signal into an electrical signal. The second scanner 400 is configured to control second laser light to be deflected from multiple different second deflection directions F2′ to the second direction F2, so that the second laser light along the second direction F2 is sent to the receiver 500. The second laser light is the light reflected by the target object 20 for the first laser light. At least one second deflection direction F2′ differs from the second direction F2.

In an example, as shown in FIGS. 8 and 9, the LiDAR assembly 10 further includes a signal processing unit. The second laser light reflected by the target object 20 is received by the receiver 500 after passing through the scanning module 700 and the second scanner 400. The signal processing unit is configured to receive the electrical signal and analyze and compute the received electrical signal to determine the distance d and shape information of the target object 20, achieving 3D modeling by the LiDAR.

In another example, as shown in FIGS. 10 and 11, the LiDAR assembly 10 may include a focusing lens 800. The second laser light reflected by the target object 20 passes through the focusing lens 800 and the second scanner 400 before being received by the receiver 500. After signal processing, the distance d and shape of the target object 20 are calculated using the time-of-flight method.

In this embodiment, by providing the second scanner 400, the multiple different second deflection directions F2′ of the second laser light are converged into the second direction F2. This allows for the effective reduction of the number of receivers 500, thereby reducing costs while maintaining the equivalent number of channels of the LiDAR assembly 10.

In one embodiment, the second scanner 400 includes a fourth optical element 410 and a fifth optical element 420. The fourth optical element 410 is positioned near the target object 20 and is used to deflect the second laser light from multiple second deflection directions into the second direction. The fifth optical element 420 is disposed between the fourth optical element 410 and the receiver 500, used to alter or maintain the polarization state of the second laser light. The structure of the fourth optical element 410 can be similar to that of the second optical element 220 mentioned above, and the structure of the fifth optical element can be similar to that of the third optical element 230, which will not be repeated here.

Furthermore, the second scanner 400 may further include a sixth optical element 430. The sixth optical element 430 is disposed between the fifth optical element 420 and the receiver 500 and is used to convert a polarization state of the second laser light from a linear polarization state to a circular polarization state, or from a circular polarization state to a linear polarization state. The structure of the sixth optical element 430 can be similar to that of the first optical element 210, which will not be repeated here.

In one embodiment, the second scanner includes M fourth optical elements. The M fourth optical elements are arranged sequentially at the side of the target object, where M is an integer greater than 1.

In one embodiment, the polarization directions of the M fourth optical elements are different.

A ratio of a deflection angle of the j-th one of the fourth optical elements to a deflection angle of the first one of the fourth optical elements is an integer greater than 1, where j is an integer greater than 1 and less than or equal to M, and the first one of the fourth optical elements is the one closest to the sixth optical element among the M fourth optical elements.

In one embodiment, the second scanner includes M fifth optical elements.

The fifth optical elements and the fourth optical elements are alternately arranged on the side of the sixth optical element facing away from the transmitter. The first one among the M fifth optical elements is disposed between the first one of the fourth optical elements and the sixth optical element.

In one embodiment, the second scanner includes one fifth optical element, and the M fourth optical elements are arranged sequentially on the side of the fifth optical element facing away from the sixth optical element.

In one embodiment, the number of pointing angles in the second scanner is 2^{M+1}−1.

In one embodiment, the LiDAR assembly 10 further includes a receiving optical component, which is disposed between the second scanner 400 and the target object 20. The second laser light reflected by the target object 20 is transmitted to the second scanner 400 through the receiving optical component.

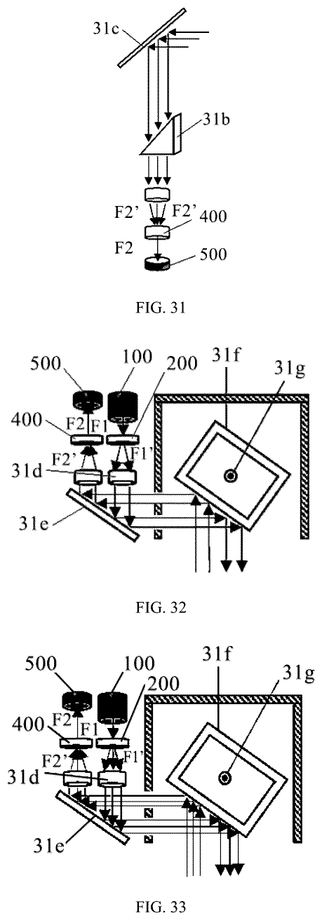

FIGS. 30 and 31 show schematic diagrams illustrating laser reception in a LIDAR assembly according to a first embodiment of the disclosure. For example, the LiDAR assembly can be a mechanical LiDAR assembly. The receiving optical component and the transmitting optical component can share the first mirror 31c and the first prism 31b. The second laser light reflected by the target object passes through the first mirror 31c, reaches the first prism 31b, and after passing through the first prism 31b, it is focused by the collimating lens, then reaches the second scanner 400, and finally reaches the receiver 500. Then the data processing and 3D environment modeling are performed by the processing chip.

As shown in FIGS. 32 and 33, the LiDAR assembly can also be a rotating mirror LIDAR assembly. The receiving optical component and the transmitting optical component can share the rotating mirror 31f and the second mirror 31e. The second laser light reflected by the target object passes sequentially through the rotating mirror 31f, the second mirror 31e, the collimating lens, and the second scanner 400 and then is received by the receiver 500. The receiver 500 converts the optical signal into an electrical signal, which is then processed by the processing unit.

FIGS. 36 and 37 show schematic diagrams illustrating laser reception in a LIDAR assembly according to the third embodiment of the disclosure. For example, the LiDAR assembly can be a MEMS LiDAR assembly. The receiving optical component and the transmitting optical component can share the resonance mirror 31h. The second laser light reflected by the target object passes sequentially through the resonance mirror 31h, the second scanner 400, and the collimating lens and then is received by the receiver 500. Finally, the data processing and 3D environment modeling are performed by the processing chip.

FIG. 39 shows a schematic diagram illustrating laser reception in the LiDAR assembly 10 according to the fourth embodiment of the disclosure. For example, the LiDAR assembly can be a FLASH LIDAR assembly. The laser reception process of the FLASH LiDAR component is the reverse of the laser emission process. The second laser light reflected by the target object passes sequentially through the second scanner 400, the collimating lens, and is received by the receiver 500. Finally, the data processing and 3D environment modeling are performed by the processing chip.

The LiDAR assembly 10 according to the embodiments of the disclosure can use the binary or ternary scanning of the first scanner 200 to increase the point cloud density in a small angular range, thus reducing the number of transmitters 100 and receivers 500 by 30% to 50%.

The disclosure further provides an apparatus with a detection function, including the LiDAR assembly 10 of any of the above embodiments. FIG. 41 shows application examples of an apparatus with detection function according to the disclosure. As shown in FIG. 41, the apparatus with detection function can be an autonomous vehicle, intelligent robot, automated logistics vehicle, or surveying equipment.

By adopting the LiDAR assembly 10 described above, the apparatus with detection function can effectively reduce the number of transmitters 100 while ensuring the equivalent number of channels of the LiDAR assembly 10, thus lowering the cost.

Other configurations of the LiDAR assembly 10 and the apparatus with the detection function of the above embodiments can adopt various technical solutions known to those skilled in the art now and in the future, which will not be described in further detail here.

In the description of this specification, it should be understood that terms such as “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, etc., indicate orientations or positional relationships based on the orientations or positional relationships shown in the drawings, and are for the convenience of describing the disclosure and simplifying the description, and are not meant to indicate or imply that the devices or components referred to must have a specific orientation, or construction and operation in a specific orientation. Therefore, these terms should not be construed as limitations of the disclosure.

In addition, the terms “first”, “second” are only used for descriptive purposes and should not be understood to indicate or imply relative importance or implicitly specify the number of the features referred to. As such, features labeled as “first”, “second”, etc., may explicitly or implicitly include one or more of the described features.

In the disclosure, unless explicitly indicated otherwise, terms such as “installed”, “connected”, “coupled”, “fixed”, etc., should be broadly interpreted. For example, they can refer to fixed connections, detachable connections, or that can be integrated; mechanical connections, electrical connections, or communication connections; direct connections or indirect connections through intermediaries; or communication between elements or interactions between components. Those skilled in the art can understand the specific meaning of these terms in the context of the disclosure based on the specific circumstances.

Furthermore, unless explicitly indicated otherwise, when a first feature is described as being “on” or “below” a second feature, this may include direct contact between the two features or contact through an additional feature between them. Likewise, the first feature being “on”, “above”, “over” the second feature may include the first feature being positioned directly or obliquely above the second feature or merely at a higher level than the second feature. The first feature being “under”, “below”, “beneath” the second feature may similarly include the first feature being directly or obliquely below the second feature or merely at a lower level than the second feature.

The above disclosure provides many different embodiments or examples to implement the various structures of the disclosure. To simplify the disclosure, specific examples of components and configurations have been described. Of course, these are just examples, and are not intended to limit the disclosure. Additionally, in the disclosure, reference numbers and/or letters can be reused multiple times across different examples, and such reuse is for the sake of simplification and clarity and does not indicate any relationship between the various embodiments and/or configurations discussed.

The above-described embodiments are merely specific examples of the disclosure, and the scope of protection of the disclosure is not limited to these. Any skilled in the art can easily think of various modifications or substitutions within the technical scope disclosed in the disclosure, which should be included within the scope of protection of the disclosure. Therefore, the scope of protection of the disclosure should be determined by the scope of the claims.

1. A Light Detection and Ranging (LiDAR) assembly, comprising:
a transmitter configured to emit first laser light along a first direction;
a first scanner, wherein an input terminal of the first scanner faces to an output terminal of the transmitter, and the first scanner is configured to control the first laser light to be deflected from the first direction to a plurality of different first deflection directions, and emit the first laser light along the plurality of first deflection directions to a target object; wherein at least one of the plurality of first deflection directions is different from the first direction;
a receiver configured to receive laser light reflected by the target object and convert an optical signal into an electrical signal; and
a signal processing unit configured to receive the electrical signal, analyze and compute the electrical signal to obtain information about a distance from the target object and a shape of the target object.

2. The LiDAR assembly according to claim 1, wherein an angle between the at least one of the plurality of first deflection directions and the first direction ranges from 0.5° to 10°.

3. The LiDAR assembly according to claim 1, wherein the first scanner comprises:
a first optical element facing to the output terminal of the transmitter, and configured to convert a polarization state of the first laser light from a linear polarization state to a circular polarization state, or convert a polarization state of the first laser light from a circular polarization state to a linear polarization state;
a second optical element disposed on a side of the first optical element facing away from the transmitter, and configured to deflect the first laser light from the first direction to the plurality of first deflection directions; and
a third optical element disposed between the first optical element and the second optical element, and configured to change or maintain the polarization state of the first laser light.

4. The LiDAR assembly according to claim 3, wherein the third optical element comprises:
a first substrate;
a first transparent electrode layer on a side of the first substrate;
a first alignment layer on a side of the first transparent electrode layer facing away from the first substrate;
a second substrate at a side of the first alignment layer facing away from the first substrate;
a second transparent electrode layer on a side of the second substrate facing to the first substrate;
a second alignment layer on a side of the second transparent electrode layer facing to the first substrate; and
a first liquid crystal layer between the first alignment layer and the second alignment layer;
wherein a first driving electric field is configured to be formed between the first transparent electrode layer and the second transparent electrode layer to change a deflection state of the first liquid crystal layer, to allow the polarization state of the first laser light to be changed or maintained.

5. The LiDAR assembly according to claim 4, wherein
a thicknesses of each of the first substrate and the second substrate ranges from 100 μm to 700 μm; and/or
a thicknesses of each of the first transparent electrode layer and the second transparent electrode layer ranges from 0.05 μm to 2 μm; and/or
a thicknesses of the first alignment layer and the second alignment layer ranges from 0.01 μm to 0.5 μm; and/or
a thickness of the first liquid crystal layer ranges from 2 μm to 5 μm.

6. The LiDAR assembly according to claim 3, wherein the second optical element comprises:
a third substrate;
a third alignment layer on a side of the third substrate;
a packaging structure at a side of the third alignment layer facing away from the third substrate; and
a second liquid crystal layer between the packaging structure and the third alignment layer.

7. The LiDAR assembly according to claim 3, wherein the second optical element comprises:
a fourth substrate;
a third transparent electrode layer on a side of the fourth substrate;
a fourth alignment layer on a side of the third transparent electrode layer facing away from the fourth substrate;
a fifth substrate at a side of the fourth alignment layer facing away from the fourth substrate;
a fourth transparent electrode layer on a the side of the fifth substrate facing to the fourth substrate;
a fifth alignment layer on a side of the fourth transparent electrode layer facing to the fourth substrate; and
a third liquid crystal layer between the fourth alignment layer and the fifth alignment layer;
wherein a second driving electric field is configured to be formed between the third transparent electrode layer and the fourth transparent electrode layer to change a deflection state of the third liquid crystal layer, to allow the first laser light to be deflected from the first direction to the plurality of first deflection directions.

8. The LiDAR assembly according claim 1, further comprising a transmitting optical component;
wherein an input terminal of the transmitting optical component faces to an output terminal of the first scanner; and
the first laser light along the plurality of first deflection directions is emitted to the target object via the transmitting optical component.

9. The LiDAR assembly according to claim 8, wherein
the transmitting optical component comprises: a first collimating lens, a first prism, and a first mirror arranged sequentially along an optical path of the first laser light, wherein the first mirror is configured to direct the first laser light to the target object; or
the transmitting optical component comprises a second collimating lens, a second mirror, and a rotating mirror arranged sequentially along an optical path of the first laser light, wherein the rotating mirror is configured to rotate around a rotation shaft and is configured to direct the first laser light to the target object; or
the transmitting optical component comprises: a resonance mirror for directing the first laser light to the target object; or
the transmitting optical component comprises: a divergent lens for directing the first laser light to the target object.

10. The LiDAR assembly according claim 1, further comprising a second scanner;
wherein the second scanner is configured to control second laser light to be deflected from a plurality of different second deflection directions to a second direction, to allow the second laser light along the second direction to be transmitted to the receiver; and
the second laser light is light reflected by the target object for the first laser light, and at least one of the plurality of second deflection directions is different from the second direction.

11. The LiDAR assembly according to claim 10, wherein the second scanner comprises:
a fourth optical element located near the target object, and configured to deflect the second laser light from the plurality of second deflection directions to the second direction; and
a fifth optical element disposed between the fourth optical element and the receiver, and configured to change or maintain a polarization state of the second laser light.

12. The LiDAR assembly according to claim 11, wherein the second scanner further comprises a sixth optical element between the fifth optical element and the receiver;
wherein the sixth optical element is configured to convert the polarization state of the second laser light from a linear polarization state to a circular polarization state, or convert the polarization state of the second laser light from a circular polarization state to a linear polarization state.

13. The LiDAR assembly according to claim 10, further comprising a receiving optical component between the second scanner and the target object;
wherein the second laser light reflected by the target object is transmitted to the second scanner via the receiving optical component.

14. The LiDAR assembly according claim 3, wherein the first scanner comprises N second optical elements;
wherein the N second optical elements are sequentially arranged on the side of the first optical element facing away from the transmitter; and
N is an integer greater than 1.

15. The LiDAR assembly according to claim 14, wherein
polarization directions of the N second optical elements are different; and
a ratio of a deflection angle of a j-th one of the N second optical elements to a deflection angle of a first one of the N second optical elements is an integer greater than 1;
wherein j is an integer greater than 1 and less than or equal to N, and among the N second elements, the first one of the N second optical elements is closest to the first optical element.

16. The LiDAR assembly according to claim 14, wherein the first scanner comprises N third optical elements;
wherein the third optical elements and the second optical elements are alternately arranged on the side of the first optical element facing away from the transmitter; and
a first one of the N third optical element is disposed between the first one of the N second optical elements and the first optical element.

17. The LiDAR assembly according to claim 14, wherein the first scanner comprises one third optical element;
wherein the N second optical elements are sequentially arranged on a side of the one third optical element facing away from the first optical element.

18. The LiDAR assembly according claim 14, wherein a quantity of pointing angles of the first scanner is 2⁺¹−1.

19. The LiDAR assembly according claim 11, wherein the second scanner comprises M fourth optical elements;
the M fourth optical elements are sequentially arranged at a side of the target object; and
M is an integer greater than 1.

20. An apparatus with a detection function, comprising the LiDAR assembly according claim 1.
